(19) United States
(12) Patent Application Publication
(10) Pub. No.: US 2019/0182854 A1
(43) Pub. Date: Jun. 13, 2019

(54) METHODS AND APPARATUSES FOR DYNAMIC RESOURCE AND SCHEDULE MANAGEMENT IN TIME SLOTTED CHANNEL HOPPING NETWORKS

(71) Applicant: CONVIDA WIRELESS, LLC, Wilmington, DE (US)

(72) Inventors: Zhuo CHEN, Claymont, DE (US); Chonggang WANG, Princeton, NJ (US); Quang LY, North Wales, PA (US); Xu LI, Plainsboro, NJ (US); Hongkun LI, Malvern, PA (US); Rocco DI GIROLAMO, Laval (CA); Shamim Akbar RAHMAN, St. Luc (CA); Vinod Kumar CHOYI, Conshohocken, PA (US)

(21) Appl. No.: 16/089,571

(22) PCT Filed: Mar. 31, 2017
(86) PCT No.: PCT/US2017/025487

§ 371 Date: Sep. 28, 2018

Related U.S. Application Data
(60) Provisional application No. 62/316,783, filed on Apr. 1, 2016.
(60) Provisional application No. 62/323,976, filed on Apr. 18, 2016.

(51) Int. Cl. H04W 72/12; H04L 12/863; H04L 12/861

(52) U.S. Cl. CPC H04W 72/1242; H04W 72/1263; H04L 49/9047; H04L 47/6295

(57) ABSTRACT

The present application is at least directed to an apparatus operating on a network. The apparatus includes a non-transitory memory including an interface queue designated for a neighboring device and having instructions stored thereon for enqueuing a received packet. The apparatus also includes a processor, operably coupled to the non-transitory memory, configured to perform a set of instructions. The instructions include receiving the packet in a cell from the neighboring device. The instructions also include checking whether a track ID is in the received packet. The instructions also include checking a table stored in the memory to find a next hop address. Further, the instructions include inserting the packet into a subqueue of the interface queue. The application is also directed to a computer-implemented apparatus configured to dequeu a packet. The application is also directed to a computer-implemented apparatus configured to adjust a bundle of a device. The application is further directed to a computer-implemented apparatus configured to process a bundle adjustment request from a device.

### CROSS-REFERENCE TO RELATED APPLICATIONS

This application claims the benefit of priority of U.S. Provisional Application No. 62/316,783 filed Apr. 1, 2016 entitled, “Methods and Apparatuses for Dynamic Resource and Schedule Management in Time Slotted Channel Hopping Networks,” and U.S. Provisional Application No. 62/323,976 filed Apr. 18, 2016 entitled, “Methods and Apparatuses for Dynamic Resource and Schedule Management in Time Slotted Channel Hopping Networks” both of which are incorporated by reference in their entireties herein.

### FIELD

The present application is directed to methods and apparatuses for dynamic resource and schedule management in a 6TiSCH network.

### BACKGROUND

Over the last decade, significant strides have been made in the field of resource and schedule management in 6TiSCH networks. In particular, time slotted channel hopping (TSCH) has been adopted to improve reliability for low power and lossy networks (LLNs). These LLNs operate in an environment with narrow-band interference and multi-path fading.

Generally, existing resource and schedule management schemes cannot reserve new resources from the source to the destination in a short period of time. For instance, each node on the path needs to negotiate with the next hop node to add scheduled cells before transmitting a packet. That is, existing schemes have difficulty delivering bursty traffic with little delay. Consequently, emergency data of high priority will not be transmitted in advance of other data packets of lower priority.

LLNs generate many negotiation messages to allocate and release resources for traffic in existing resource and schedule management schemes. This is especially true for bursty traffic which lasts for a short period of time. Hence, these negotiation messages introduce significant overhead into the network.

In existing architectures, the 6top Protocol (6P) allows two neighbor nodes to pass information in order to add or delete cells to TSCH schedules. However, the protocols do not specify bundle information with these cells. By so doing, two neighbor nodes cannot dynamically adjust cells associated with one or more bundles resulting in decreased efficiency of the network.

### SUMMARY

This summary is provided to introduce a selection of concepts in a simplified form that are further described below in the Detailed Description. This Summary is not intended to limit the scope of the claimed subject matter. The foregoing needs are met, to a great extent, by the present application directed to a process and system for dynamic resource and schedule management in a 6TiSCH network.

One aspect of the application, describes a computer-implemented apparatus operating on a network. The apparatus includes a non-transitory memory including an interface queue that stores a packet for a neighbor device. The interface queue has subqueues including a high priority subqueue, a track subqueue, and a best effort subqueue. The apparatus also includes a processor, operably coupled to the non-transitory memory, configured to perform instructions of determining which of the subqueues to store the packet.

In another aspect of the application, a computer implemented apparatus operating on a network is described. The apparatus includes a non-transitory memory including an interface queue designated for a neighboring device and having instructions stored thereon for enqueuing a received packet. The apparatus also includes a processor, operably coupled to the non-transitory memory, configured to perform a set of instructions. The instructions include receiving the packet in a cell from the neighboring device. The instructions also include checking whether a track ID is in the received packet. The instructions also include checking a table stored in the memory to find a next hop address. Further, the instructions include inserting the packet into a subqueue of the interface queue.

Yet another aspect of the application is directed to a computer implemented apparatus operating on a network. The apparatus includes a non-transitory memory having an interface queue designated for a neighboring device and instructions stored thereon for dequeuing a packet. The apparatus also includes a processor, operably coupled to the non-transitory memory, configured to perform a set of instructions. The instructions include evaluating the packet in a cell should be transmitted to the neighboring device. The instructions also include determining whether a high priority subqueue of the interface queue is empty. The instructions also include dequeuing the packet. The instructions further include transmitting the packet to the neighboring device.

In a further aspect of the application is directed to a computer implemented apparatus operating on a network. The apparatus includes a non-transitory memory including an interface queue with a subqueue for a neighboring device, and having instructions stored thereon for adjusting a bundle of the device in the network. The apparatus also includes a processor, operably coupled to the non-transitory memory, configured to perform a set of instructions. The instructions include monitoring the length of the subqueue of the device. The instructions also include determining the difference between the subqueue and a threshold value. The instructions also include generating a bundle adjustment request to adjust the size of the subqueue. The instructions further include sending the bundle adjustment request to the device.

In yet even a further aspect of the application is directed to a computer implemented apparatus operating on a network. The apparatus includes a non-transitory memory including an interface queue with a subqueue for a neighboring device, and having instructions stored thereon for processing a bundle adjustment request from the neighboring device. The apparatus also includes a processor, operably coupled to the non-transitory memory, configured to perform the set of instructions. The instructions include receiving a bundle adjustment request. The instructions also include extracting the requested information. The instructions also include generating a response in view of the extracted information. The instructions further include transmitting a response to the device.

There has thus been outlined, rather broadly, certain embodiments of the invention in order that the detailed description thereof may be better understood, and in order that the present contribution to the art may be better appreciated.

### BRIEF DESCRIPTION OF THE DRAWINGS

In order to facilitate a more robust understanding of the application, reference is now made to the accompanying drawings, in which like elements are referenced with like numerals.

These drawings should not be construed to limit the application and are intended only to be illustrative.

FIG. 1 illustrates an industrial monitor system over low-power and lossy networks (LLNs).

FIG. 2 illustrates a 6TiSCH operation sublayer in a TiSCH protocol stack.

FIG. 3 illustrates an exemplary architecture of a 6TiSCH network.

FIG. 4 illustrates a general format of a payload information element in IEEE 802.15.4.

FIG. 5A illustrates a system diagram of an exemplary machine-to-machine (M2M) or Internet of Things (IoT) communication system in which one or more disclosed embodiment may be implemented.

FIG. 5B illustrates an embodiment of the application of a M2M service platform.

FIG. 5C illustrates an embodiment of the application of a system diagram of an example M2M device.

FIG. 5D illustrates an embodiment of the application of a block diagram of an exemplary computing system.

FIG. 6 illustrates an interface queue associated with a neighbor LLN device according to an embodiment of the application.

FIG. 7 illustrates an interface queue associate with each one-hop neighbor LLN device of an LLN device according to an embodiment of the application.

FIG. 8 illustrates the receiving and forwarding of packets from a LLN device according to an embodiment of the application.

FIG. 9 illustrates a flowchart for an LLN device to enqueue a received packet according to an embodiment of the application.

FIG. 10 illustrates a flowchart for an LLN device to dequeue and transmit a packet according to an embodiment of the application.

FIG. 11 illustrates a flowchart for queue monitoring and bundle adjustment triggering according to an embodiment of the application.

FIG. 12 illustrates a bundle adjustment procedure according to an embodiment of the application.

FIG. 13 illustrates a procedure for a LLN device to process a bundle adjustment request according to an embodiment of the application.

FIG. 14 illustrates 6TiSCH traffic priority management field in IEEE 802.15.4 information element according to an embodiment of the application.

FIG. 15 illustrates a 6TiSCH control message in IEEE 802.15.4 information element according to an embodiment of the application.

FIG. 16 illustrates an add/delete cell protocol using 6TOP protocol according to an embodiment of the application.

### DETAILED DESCRIPTION OF THE ILLUSTRATIVE EMBODIMENTS

A detailed description of the illustrative embodiment will be discussed in reference to various figures, embodiments and aspects herein. Although this description provides detailed examples of possible implementations, it should be understood that the details are intended to be examples and thus do not limit the scope of the application.

Reference in this specification to “one embodiment,” “an embodiment,” “one or more embodiments,” “an aspect” or the like means that a particular feature, structure, or characteristic described in connection with the embodiment is included in at least one embodiment of the disclosure. Moreover, the term “embodiment” in various places in the specification is not necessarily referring to the same embodiment. That is, various features are described which may be exhibited by some embodiments and not by the other.

Generally, the application is directed to dynamically managing resources and schedules in 6TiSCH networks. The resource and schedule management is referred to as managing underlying network resources, e.g., timeslots, channel frequencies, between a LLN device and its neighbor LLN device(s).

One aspect of the application is directed to systems and methods that enable 6TiSCH devices to manage traffic with different priorities and to dynamically allocate scheduled cells to deliver high priority traffic that requires small delay. In one embodiment, a new interface queue model that manages traffic with different priorities is envisaged. In another embodiment, new transmitting and receiving procedures are envisaged that dynamically allocate resources between track traffic and best effort traffic. These protocols preferably do not introduce extra messages to allocate and release cells. According to another embodiment, a method is envisaged that enables an LLN device to dynamically increase or decrease the size of a bundle.

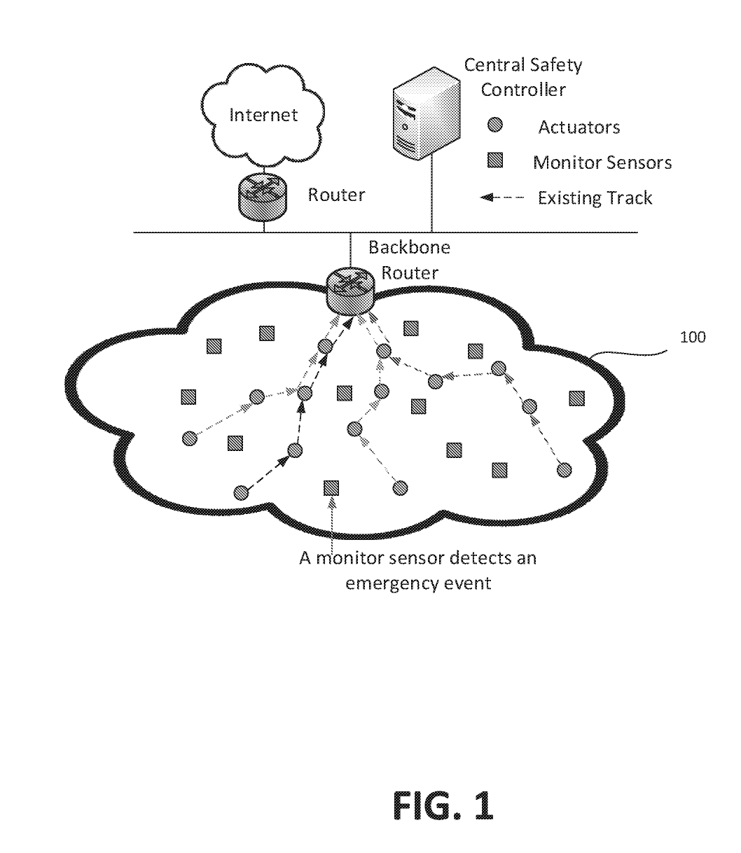

In an exemplary embodiment, FIG. 1 illustrates a use case of a 6TiSCH network for an industrial network 100. The network 100 includes plural plants. Many LLN devices are installed on each plant. Some LLN devices are actuators on an automation assembly line denoted by a circle. When an actuator finishes a task, it generally sends a signaling packet to the next actuator on the assembly line to trigger the next action. Reliability of these signaling packets is extremely important since packet loss may result in products with defects. To prevent loss, several tracks, denoted by a dotted line, are reserved along the assembly lines.

Meanwhile, other LLN devices in the network 100 are safety monitor sensors denoted by a square. The safety monitor sensors do not have periodical data to send to the central safety controller in the network. The safety monitor sensors also are not trackless. When a safety monitor sensor detects an abnormal event, the LLN device triggers an emergency alarm and generates a data flow that contains monitored data. According to the priority of the message, it may be reserved in a queue separate from a track queue and transmitted with small delay.

### Acronyms and Definitions

Provided below are acronyms for terms and phrases commonly used in this application in Table 1. Thereafter are definitions for commonly used terms and phrases in this application.

TABLE 1

| Acronym | Description |
|---|---|
| 6TiSCH | IETF IPv6 over the TSCH mode of IEEE 802.15.4e |
| 6top | 6TiSCH Operation Sublayer |
| ACK | Acknowledgement |
| BR | Backbone Router |
| CoAP | Constrained Application Protocol |
| CSMA | Carrier Sense Multiple Access |
| DE-MUX | Demultiplexer |
| Dst | Destination |
| IANA | Internet Assigned Numbers Authority |
| ICMP | Internet Control Message Protocol |
| IE | Information Element |
| IP | Internet Protocol |
| LLN | Low power and Lossy Network |
| MAC | Medium Access Control |
| MHR | MAC Header |
| MPLS | Multiprotocol Label Switching |
| MUX | Multiplexer |
| RPL | IPv6 Routing Protocol for Low-Power and Lossy Networks |
| SAP | Service Access Points |
| Src | Source |
| SF | Scheduling Function |
| TCP | Transmission Control Protocol |
| TSCH | Time Slotted Channel Hopping |
| UDP | User Datagram Protocol |

| | |
|---|---|
| Bundle | A group of equivalent scheduled cells, i.e., cells identified by different |
| | [slotOffset, channelOffset], which are scheduled for the same purpose, |
| | with the same neighbor, with the same flags, and with the same slot frame. |
| Cell | A single element in the TSCH schedule matrix, identified by a timeslot |
| | offset value along the x-axis and a channel offset value along the y-axis. |
| Channel Hopping | Packets are transmitted by choosing a different carrier frequency among |
| | many available sub-carriers at different timeslots. |
| Frame | A unit of transmission in a link layer protocol, and consists of a link layer |
| | header followed by a packet. We use the term packet and frame |
| | interchangeably in the document |
| Hard Cell | A scheduled cell that is configured by a central controller and cannot be |
| | further configured/modified by the LLN device itself |
| Scheduled Cell | A cell with a pre-determined type, timeslot offset and channel offset. |
| Slotframe | Timeslots are grouped into one or more slotframes. A slotframe continuously |
| | repeats over time. |
| Soft Cell | A scheduled cell that is configured by the LLN device itself and can be |
| | further configured by either the LLN device or by the centralized controller. |
| Timeslot | Time is sliced up into timeslots, which are grouped into one or more |
| | slotframes |
| Track | A determined sequence of cells along a path from the source to destination. |
| | It is typically the result of a reservation. |
| TSCH Schedule | A matrix of cells, each cell indexed by a timeslot offset and a channel offset. |

The term “service layer” refers to a functional layer within a network service architecture. Service layers are typically situated above the application protocol layer such as HTTP, CoAP or MQTT and provide value added services to client applications. The service layer also provides an interface to core networks at a lower resource layer, such as for example, a control layer and transport/access layer. The service layer supports multiple categories of (service) capabilities or functionalities including service definition, service runtime enablement, policy management, access control, and service clustering. Recently, several industry standards bodies, e.g., oneM2M, have been developing M2M service layers to address the challenges associated with the integration of M2M types of devices and applications into deployments such as the Internet/Web, cellular, enterprise, and home networks. A M2M service layer can provide applications and/or various devices with access to a collection of or a set of the above mentioned capabilities or functionalities, supported by the service layer, which can be referred to as a common service entity or service capability layer. A few examples include but are not limited to security, charging, data management, device management, discovery, provisioning, and connectivity management which can be commonly used by various applications. These capabilities or functionalities are made available to such various applications via APIs which make use of message formats, resource structures and resource representations defined by the M2M service layer. The common service entity or service capability layer is a functional entity that may be implemented by hardware and/or software and that provides (service) capabilities or functionalities exposed to various applications and/or devices (i.e., functional interfaces between such functional entities) in order for them to use such capabilities or functionalities.

### TSCH Mode of IEEE 802.15.4e

IEEE802.15.4e was chartered to define a MAC amendment to the existing standard 802.15.4-2006 which adopts a channel hopping strategy to improve the reliability LLNs. The LLNs include networks that operate in an environment with narrow-band interference and multi-path fading.

Time Slotted Channel Hopping (TSCH) is one of the medium access modes specified in IEEE 802.15.4e standard. In the TSCH mode of IEEE 802.15.4e: (i) time is divided into several timeslots; (ii) the beacon is transmitted periodically for time synchronization, (iii) timeslots are grouped into one or more slotframes; and (iv) a slotframe continuously repeats over time.

For example, TABLE 2A shows a TSCH schedule example, i.e., a matrix of cells, of two slotframes, where the x-axis is the timeslot offset and y-axis is the channel offset. The depicted slotFrames have 16 channels and 100 Timeslots. Due to the property of channel hopping, an LLN device may use different channels in different timeslots as shown in TABLE 2A. A single element in the TSCH slotframe, named as a “Cell”, is identified by a timeslot offset value and a channel offset value. Typically, a given cell could be a “scheduled cell,” i.e., TxS, Rx or Tx, or an “unscheduled cell,” i.e., empty cells. In particular, a scheduled cell is regarded as a “hard cell” if it is configured by a central controller. That is, the cell cannot be further configured/modified by the LLN device itself.

In comparison, a scheduled cell is regarded as a “soft cell” if it was only configured by the LLN device itself and can be further configured by either the LLN device or by the centralized controller. However, once a soft cell is configured by the centralized controller, it will become a hard cell accordingly. A matrix of cells is referred to as the TSCH schedule which is the resource management unit in 6TiSCH networks. In other words, a TSCH schedule consists of a few contiguous cells. In order to receive or transmit packets, an LLN device needs to get a schedule. TABLE 2A shows an example of an LLN device's TSCH schedule, where:

The LLN device may transmit or receive a packet at timeslot 0 using channel 0. This type of cell is shared by all LLN devices in the network. A backoff algorithm is used to resolve contention. The shared slots can be used for broadcast transmission.

The LLN device turns on its radio to receive an incoming packet from a pre-configured transmitter at timeslot 1 over channel 1 and potentially send back the ACK at the same slot.

The LLN device may transmit a packet to a pre-configured LLN at timeslot 2 using channel 15.

The LLN device may turn off its radio and go to sleep mode in any unscheduled cell, e.g., in timeslot 99.

TSCH is the emerging standard for industrial automation and process control using LLNs, with a direct inheritance from WirelessHART and ISA100.11a. These protocols are different from the 802.11 family of protocols that employ CSMA as their foundation.

### 6TiSCH Networks

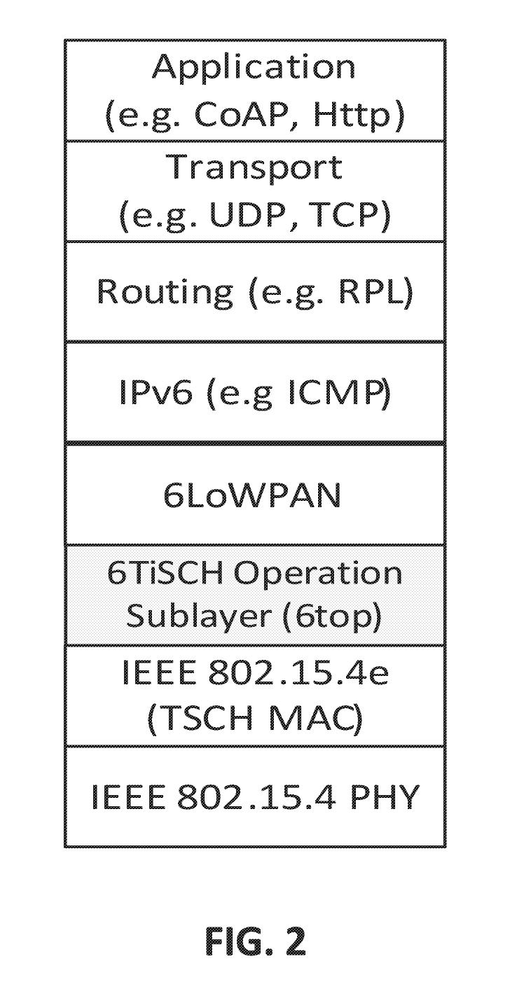

A 6TiSCH network usually consists of constrained devices that use TSCH mode of 802.15.4e as Medium Access Control (MAC) protocol. IETF 6TiSCH Working Group is specifying protocols for addressing network layer issues of 6TiSCH networks. For example, to manage a TSCH Schedule, a 6TiSCH Operation Sublayer (6top) is proposed in 6TiSCH Working Group. 6top is a sublayer which is the next-higher layer for IEEE 802.15.4e TSCH MAC as shown in FIG. 2, i.e., 3^{rd} row from the bottom. 6top is responsible for picking the exact slotOffset and channelOffset in the schedule. 6top deals with the allocation process by negotiating with the target node. 6top offers both management and data interfaces to an upper layer. For example, 6top offers commands such as READ/CREATE/UPDATE/DELETE to modify its resource, e.g., TSCH Schedule, as listed in TABLE 2A above. 6top also feeds the data flow coming from upper layers into TSCH.

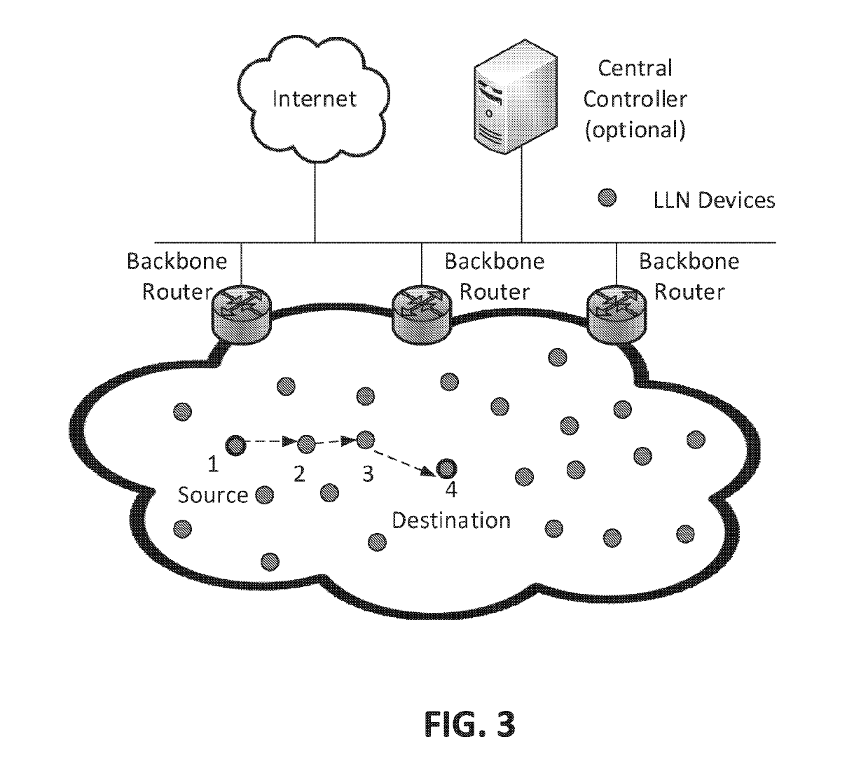

6TiSCH network reference architecture as defined by IETF 6TiSCH Working Group is shown in FIG. 3. There are two types of device, i.e., BRs and LLN devices, in a 6TiSCH network.

BRs are powerful devices that are located at the border of a 6TiSCH network. The BRs work as a gateway to connect 6TiSCH network to the Internet.

LLN devices have constrained resources, e.g., limited power supply, memory, processing capability. They connect to one or more BRs via single hop or multi-hop communications. Due to the limited resources, LLN devices may not be able to support complicated protocols such as Transmission Control Protocol (TCP). However, LLN devices can support network layer protocols such as ICMP protocol.

A 6TiSCH network may be managed by a central controller as shown in FIG. 3. The central controller has the capability of calculating not only the routing path between a source and a destination but also configuring the TSCH Schedule as shown in TABLE 2A for each of the LLN devices on the path in a centralized way.

Due to the TSCH nature of a 6TiSCH network, MAC-layer resources, e.g., timeslot and channel, need to be allocated for LLN devices in order to communicate with each other via single or multiple hops, e.g., LLN device 1 communicates with LLN device 4 via multiple hops as shown in FIG. 3. This is referred to as the resource and schedule management issue in 6TiSCH networks.

### Tracks in 6TiSCH Networks

By configuring the TSCH schedule of LLN devices on a route, e.g., from LLN device 1 to LLN device 4 as shown in FIG. 3, a track can be reserved to enhance the multi-hop communications between the source and the destination as highlighted in. An LLN device on the track not only knows what cells it should use to receive packets from its previous hop, e.g., LLN device 2 knows that LLN device 1 will transmit a packet in slot 1 using channel 0, slot 2 using channel 1 and slot 3 using channel 0, but it also knows what cells it should use to send packets to its next hop, e.g., LLN device 2 knows it shall transmit a packet to LLN device 3 in slot 20 channel 2, slot 21 channel 0 and slot 22 channel 15. In this way, a group of cells set to receive (RX-cells) is uniquely paired to a group of cells that are set to transmit (TX-cells), representing a layer-2 forwarding state that can be used regardless of the network layer protocol. As long as the TSCH MAC accepts a packet, that packet can be switched regardless of the protocol, whether this is an IPv6 packet, a 6LoWPAN fragment, or a frame from an alternate protocol such as WirelessHART or ISA100.11a.

A data frame that is forwarded along a track normally has a destination MAC address that is set to a broadcast—or a multicast address depending on MAC support. In this way, the MAC layer in the intermediate nodes accept the incoming frame and 6top switches it without incurring a change in the MAC header.

By using the track, the throughput and delay of the path between the source and the destination can be guaranteed, which is extremely important for industrial automation and process control.

However, how a track is reserved has not been specified yet in 6TiSCH Working Group.

TABLE 2B

| | Timeslot Offset | | | | | | | | | | | |
|---|---|---|---|---|---|---|---|---|---|---|---|---|
| Channel Offset | 0 | 1 | 2 | 3 | . . . | 20 | 21 | 22 | . . . | 97 | 98 | 99 |
| 0 | | Tx | | Tx | | | | | | | | |
| 1 | | | Tx | | | | | | | | | |
| 2 | | | | | | | | | | | | |
| . . . | | | | | | | | | | | | |
| 15 | | | | | | | | | | | | |

TABLE 2C

| | Timeslot Offset | | | | | | | | | | | |
|---|---|---|---|---|---|---|---|---|---|---|---|---|
| Channel Offset | 0 | 1 | 2 | 3 | . . . | 20 | 21 | 22 | . . . | 97 | 98 | 99 |
| 0 | | Rx | | Rx | | | Tx | | | | | |
| 1 | | | Rx | | | | | | | | | |
| 2 | | | | | | Tx | | | | | | |
| . . . | | | | | | | | | | | | |
| 15 | | | | | | | | Tx | | | | |

TABLE 2D

| | Timeslot Offset | | | | | | | | | | | |
|---|---|---|---|---|---|---|---|---|---|---|---|---|
| Channel Offset | 0 | 1 | 2 | 3 | . . . | 20 | 21 | 22 | . . . | 97 | 98 | 99 |
| 0 | | | | | | | Rx | | | | | Tx |
| 1 | | | | | | | | | | Tx | | |
| 2 | | | | | | Rx | | | | | Tx | |
| . . . | | | | | | | | | | | | |
| 15 | | | | | | | | Rx | | | | |

TABLE 2E

| | Timeslot Offset | | | | | | | | | | | |
|---|---|---|---|---|---|---|---|---|---|---|---|---|
| Channel Offset | 0 | 1 | 2 | 3 | . . . | 20 | 21 | 22 | . . . | 97 | 98 | 99 |
| 0 | | | | | | | | | | | | Rx |
| 1 | | | | | | | | | | Rx | | |
| 2 | | | | | | | | | | | Rx | |
| . . . | | | | | | | | | | | | |
| 15 | | | | | | | | | | | | |

There are centralized, hybrid and distributed track reservation schemes. In the centralized scheme, each LLN device in the network pro-actively reports its TSCH schedule and topology information to the central controller of the network. To reserve a track, the source LLN device sends a request to the central controller, and the central controller calculates both the route and schedule, and sets up hard cells in the TSCH schedule of LLN devices. In the hybrid scheme, each LLN device in the network pro-actively reports its topology information to its BR and the BRs communicate with each other to obtain the global topology information of the network. To reserve a track, the source LLN device sends a request to its BR, and the BR replies with candidate routes from source to the destination. LLN devices on the route then negotiate and set up soft cells in their TSCH schedule to communicate with each other. In the distributed scheme, the source will initiate a track discovery process to discover multiple candidate paths that have enough resource to satisfy the requirements of the communication between the source and the destination. The destination will select a path (from the paths discovered) as the track and may also calculate the resources required along the track. The destination will start a track selection reply process which will reserve the resources along the track between the source and the destination.

### Bundles in 6TiSCH Networks

In order for an LLN device to efficiently manage resources, equivalent scheduled cells are grouped as a bundle. Equivalent scheduled cells are schedule cells, which are scheduled for the same purpose, e.g., associated with the same track, with the same neighbor, with the same flags, e.g., Tx, Rx or Shared, and in the same slotframe. The size of the bundle refers to the number of cells it contains. Given the length of the slotframe, the size of the bundle translates directly into bandwidth. A bundle represents a half-duplex link between nodes, one transmitter and one or more receivers, with a bandwidth that equals to the sum of the cells in the bundle.

A bundle is globally identified by (source MAC, destination MAC, TrackID). There are two types of bundles. One type is a “per hop bundle” and also named layer 3 bundle, which is a bundle with a Track ID that equals to NULL. A pair of layer 3 bundles forms an IP link, e.g., the IP link between adjacent nodes A and B comprises 2 bundles: (macA, macB, NULL) and (macB, macA, NULL). The other type is a “Track Bundle” and also named layer 2 bundle, which is a bundle with Track ID that is not equal to NULL. For example, consider the segment LLN 1-LLN 2-LLN3 along the track shown in FIG. 3. Here there are two bundles managed by LLN 2, one is an incoming bundle (LLN 1, LLN 2, TrackId) as highlighted in green and the other one is outgoing bundle (LLN 2, LLN 3, TrackId) as highlighted in blue. In this example, each bundle contains three cells.

The track bundles and per hop bundles can share scheduled cells with each other. When all of the frames that were received for a given track are effectively transmitted, any available TX-cell for that track can be reused for upper layer traffic for which the next-hop router matches the next hop along the track. On the other hand, when there are not enough TX-cells in the transmit bundle to accommodate the track traffic, the frame can be placed for transmission in the bundle that is used for layer-3 traffic towards the next hop. In this case, the MAC address should be set to the next-hop MAC address to avoid confusion. It results that a frame that is received over a layer-3 bundle may be in fact associated to a track. Therefore, a frame should be re-tracked if the per-hop-behavior group indicated in the differentiated services field in the IPv6 header is set to deterministic forwarding. A frame is re-tracked by scheduling it for transmission over the transmit bundle associated to the track, with the destination MAC address set to broadcast.

### Scheduling Function in 6TiSCH Networks

The 6top sublayer includes a 6top Scheduling Function (SF) which defines the policy for when a node needs to add/delete a cell to a neighbor, without requiring any intervention of a central controller. The scheduling function retrieves statistics from 6top, and uses that information to trigger 6top to add/delete soft cells to a particular neighbor. SF0 is a proposed scheduling function on layer 3 links for best effort traffic but not for traffic associated with a track.

SF0 defines an “Allocation Policy” that contains a set of rules used by SF0 to decide when to add/delete cells to a particular neighbor to satisfy the bandwidth requirements based on the following parameters:

SCHEDULEDCELLS: The number of cells scheduled from the current node to a particular neighbor.

REOUIREDCELLS: The number of cells calculated by the Bandwidth Estimation Algorithm from the current node to that neighbor.

SF0THRESH: Threshold parameter is a hysteresis value to increase or decrease the number of cells. It is a non-negative value expressed as number of cells.

The SF0 allocation policy compares REQUIREDCELLS with SCHEDULEDCELLS and decides to add/delete cells taking into account SF0THRESH based on following rules.

1. If REQUIREDCELLS <(SCHEDULEDCELLS-SF0THRESH), delete one or more cells.

2. If (SCHEDULEDCELLS SF0THRESH)<=REQUIREDCELLS <=SCHEDULEDCELLS, do nothing.

3. If SCHEDULEDCELLS <=REQUIREDCELLS, add one or more cells.

### 6top Protocol

The 6top Protocol (6P) allows two neighbor nodes to pass information to add/delete cells to their TSCH schedule. This information is carried as IEEE802.15.4 Information Elements (IE) and travels only a single hop.

Conceptually, two neighbor nodes “negotiate” the location of the cells to add/delete. We reuse the topology in FIG. 3 to illustrate how the protocol works. When LLN device 1 wants to add (resp. delete) 2 cells to LLN device 2:

1. LLN device 1 sends a message to LLN device 2 indicating it wants to add/delete 2 cells to LLN device 2 to its schedule, and listing 2 or more candidate cells.

2. LLN device 2 responds with a message indicating that the operation succeeded, and specifying which cells from the candidate list it added/deleted. This allows LLN device 1 to add/delete the same cells to/from its schedule.

For example, all 6P messages have a format provided below in TABLE 3A:

TABLE 3A
Bit offset

| 0-3 | 4-7 | 8-15 | 16-23 | 24- |
|---|---|---|---|---|
| Version | Code | Checksum | Message | Other Fields . . . |

The list of command identifiers and return codes are provided below in TABLE 3B and TABLE 3C, respectively:

TABLE 3B

| Value | Command ID | Description |
|---|---|---|
| IANA_6TOP_CMD_ADD | CMD_ADD | add one or more |
| | | cells |
| IANA_6TOP_CMD_DELETE | CMD_DELETE | delete one or more |
| | | cells |
| IANA_6TOP_CMD_COUNT | CMD_COUNT | count scheduled |
| | | cells |
| IANA_6TOP_CMD_LIST | CMD_LIST | list the scheduled |
| | | cells |
| IANA_6TOP_CMD_CLEAR | CMD_CLEAR | clear all cells |

| | |
|---|---|
| TODO-0xf | reserved |

TABLE 3C

| Value | Command ID | Description |
|---|---|---|
| IANA_6TOP_RC_SUCCESS | RC_SUCCESS | operation |
| | | succeeded |
| IANA_6TOP_RC_VER_ERR | RC_VER_ERR | unsupported 6P |
| | | version |
| IANA_6TOP_RC_SFID_ERR | RC_SFID_ERR | unsupported SFID |
| IANA_6TOP_RC_BUSY | RC_BUSY | handling previous |
| | | request |
| IANA_6TOP_RC_RESET | RC_RESET | abort 6P |
| | | transaction |
| IANA_6TOP_RC_ERR | RC_ERR | operation failed |

| | |
|---|---|
| TODO-0xf | reserved |

SFID (6top Scheduling Function Identifier): The identifier of the SF to use to handle this message.

Other Fields: The list of other fields depends on the value of the code field, as detailed below.

The 6P Cell is an element which is present in several messages. It is a 4-byte field formatted as provided below in TABLE 3D:

TABLE 3D
Bit offset

| 0-15 | 16-31 |
|---|---|
| slotOffset | ChannelOffset |

The format of a 6P add request is provided below in TABLE 3E:

TABLE 3E
Bit offset

| 0-3 | 4-7 | 8-15 | 16-23 | 24-31 | 32- |
|---|---|---|---|---|---|
| Version | Code | SFID | NumCells | Container | CellList |

Code: Set to IANA_CMD_ADD for a 6P ADD Request.

SFID: Identifier of the SF to be used by the receiver to handle the message

NumCells: The number of additional TX cells the sender wants to schedule to the receiver.

Container: An indication of where in the schedule to take the cells from (which slotframe, which chunk, etc.). This value is an indication to the SF. The meaning of this field depends on the SF, and is hence out of scope of this document.

CellList: A list of 0, 1 or multiple 6P Cells.

Separately, the 6P DELETE Request has the exact same format as the 6P ADD Request, except for the code which is set to IANA_CMD_DELETE.

The format of a 6P count request is provided below in TABLE 3F:

TABLE 3F
Bit offset

| 0-3 | 4-7 | 8-15 | 16-23 |
|---|---|---|---|
| Version | Code | SFID | Container |

Code: Set to IANA_CMD_COUNT for a 6P COUNT Request.

SFID: Identifier of the SF to be used by the receiver to handle the message.

Container: An indication of where in the schedule to take the cells from (which slotframe, which chunk, etc.). This value is an indication to the SF. The meaning of this field depends on the SF, and is hence out of scope of this document.

The format of a 6P response is provided below in TABLE 3G:

TABLE 3G

| Bit | | | | |
|---|---|---|---|---|
| offset | 0-3 | 4-7 | 8-15 | 16- |

| | | | |
|---|---|---|---|
| Version | Code | SFID | Other Fields . . . |

SFID: Identifier of the SF to be used by the receiver to handle the message.

Code: One of the 6P Return codes

Other Fields: The fields depends on what command the request is for:

1. Response to an ADD, DELETE or LIST command: A list of 0, 1 or multiple 6P cells.

2. Response to COUNT command: The number of cells scheduled from the requestor to the receiver by the 6P protocol, encoded as a 2-octet unsigned integer.

### ICMPv6 Protocol

ICMPv6 specified in RFC 4443, is used by hosts and routers to communicate network-layer information to each other. ICMPv6 is often considered as part of IP. ICMPv6 messages are carried inside IP datagrams. The ICMPv6 message format is shown in TABLE 4. Each ICMPv6 message contains three fields that define its purpose and provide a checksum. They are Type, Code, and Checksum fields. The Type field identifies the ICMPv6 message, the Code field provides further information about the associated Type field, and the Checksum provides a method for determining the integrity of the message. Any field labeled “unused” is reserved for later extensions and must be zero when sent, but receivers should not use these fields (except to include them in the checksum). According to Internet Assigned Numbers Authority (IANA), the Type numbers of 159-199 are unassigned.

TABLE 4

| Bit | | | | |
|---|---|---|---|---|
| offset | 0-7 | 8-15 | 16-31 | 32- |

| | | | |
|---|---|---|---|
| Type | Code | Checksum | Message |

### 802.15.4 IE

An information element (IE) is a well-defined, extensible mechanism to exchange data at the MAC sublayer. An IE provides a flexible, extensible, and easily implementable method of encapsulating information. There are two IE types: Header IEs and Payload IEs. Header IEs are used by the MAC to process the frame. Header IEs cover security, addressing, etc., and are part of the MAC Header (MHR). Payload IEs are destined for another layer or Service Access Point (SAP) and are part of the MAC payload. An example of an IE in a data frame format is shown in TABLE 5.

TABLE 5

| Octets: 2 | 0/1 | Variable | 0/1/5/6/10/14 | variable | | Variable | 2 |
|---|---|---|---|---|---|---|---|
| Frame | Sequence | Addressing | Auxiliary | Information Elements | | Data | FCS |
| Control | Number | Fields | Security | Header | Payload | Payload | |
| | | | Header | IBs | IBs | | |

| | | |
|---|---|---|
| MHR | MAC Payload | MFR |

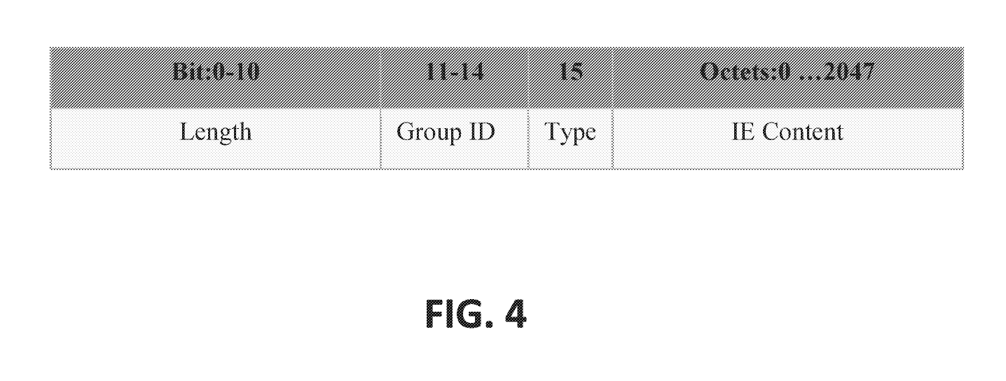

The general format of a payload IE consists of an identification (ID) field, a length field, and a content field as shown in FIG. 4 and the fields in payload IE are shown in TABLE 6.

TABLE 6

| Fields name | Description |
|---|---|
| Length | The length of the IE |
| Group ID | The Group ID can be set as an unreserved value |
| | between 0x2-0x9, e.g. 0x2. |
| T | Set to 1 to indicate this is a long format packet |
| IE Content | The content of the IE. |

### General Architecture

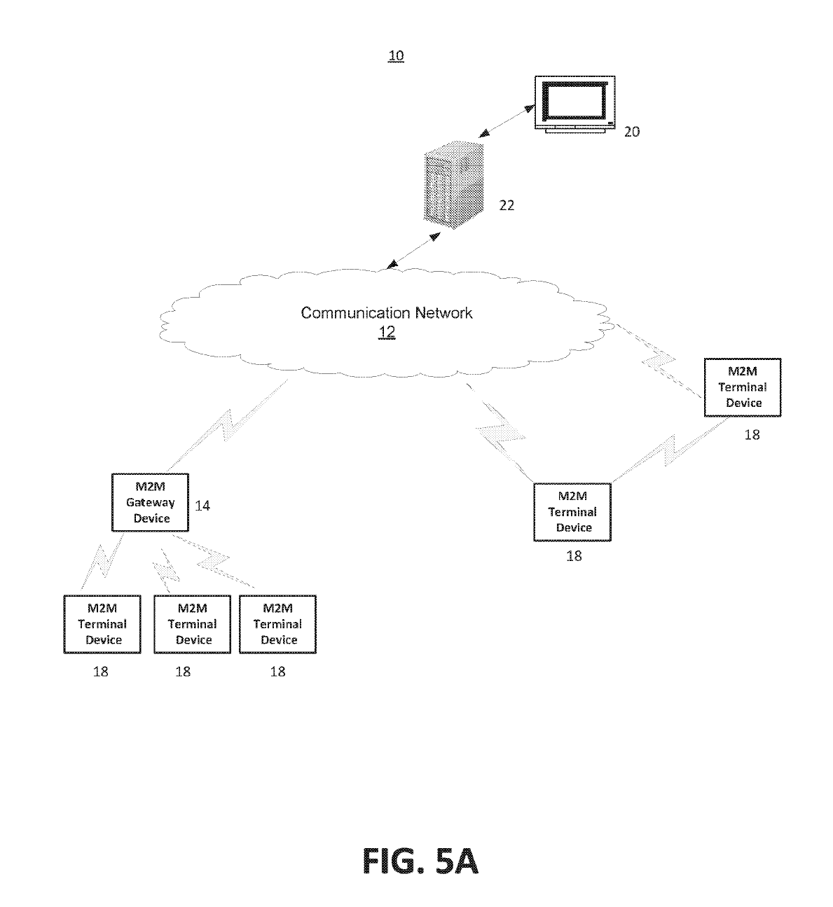

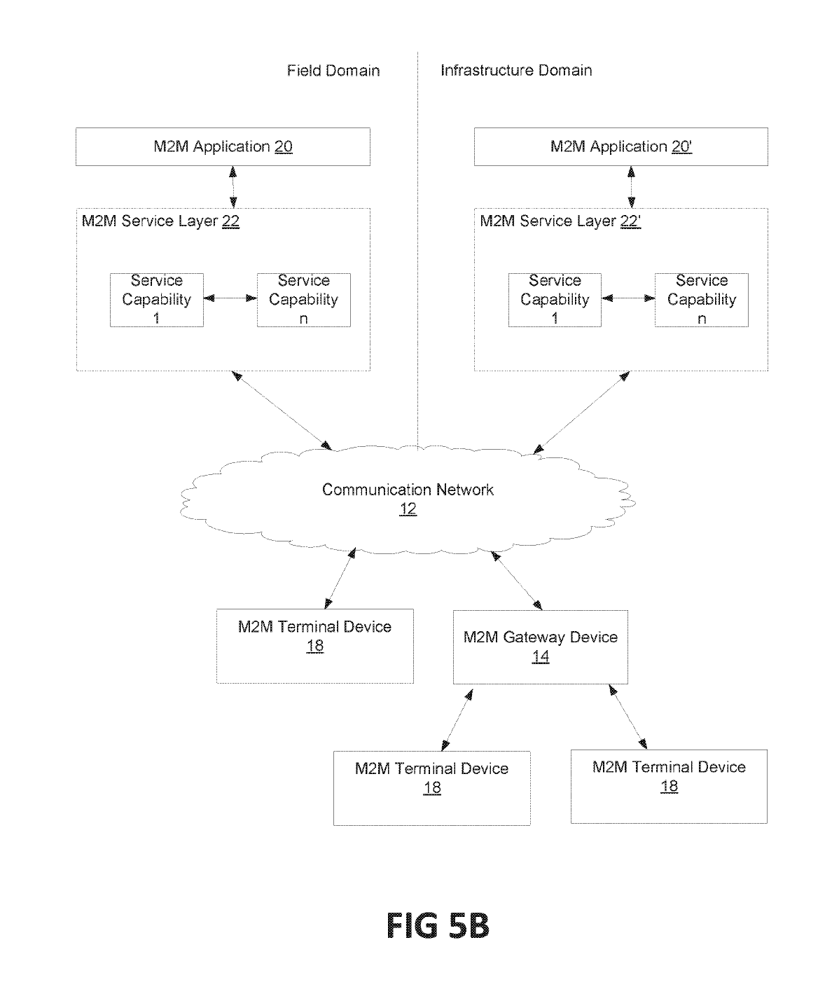

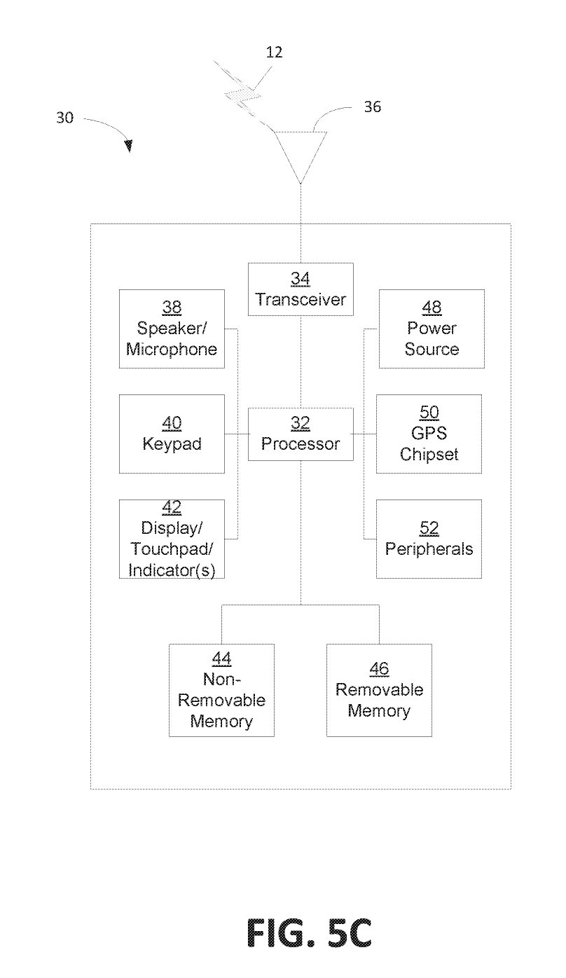

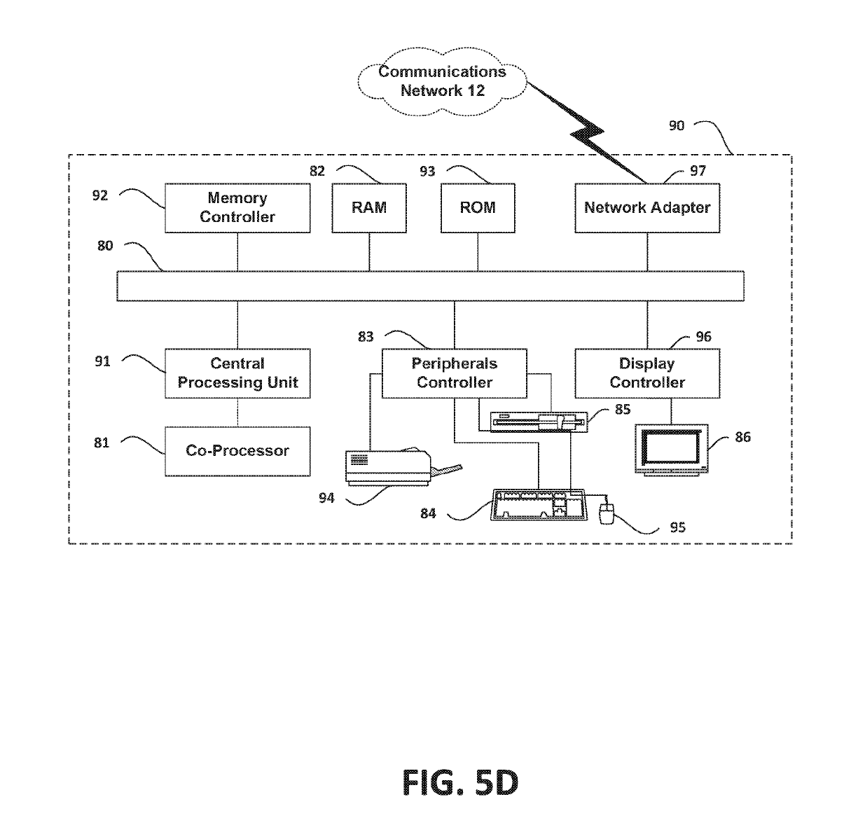

FIG. 5A is a diagram of an example machine-to machine (M2M), Internet of Things (IoT), or Web of Things (WoT) communication system 10 in which one or more disclosed embodiments may be implemented. Generally, M2M technologies provide building blocks for the IoT/WoT, and any M2M device, gateway or service platform may be a component of the IoT/WoT as well as an IoT/WoT service layer, etc.

As shown in FIG. 5A, the M2M/IoT/WoT communication system 10 includes a communication network 12. The communication network 12 may be a fixed network, e.g., Ethernet, Fiber, ISDN, PLC, or the like or a wireless network, e.g., WLAN, cellular, or the like, or a network of heterogeneous networks. For example, the communication network 12 may comprise of multiple access networks that provides content such as voice, data, video, messaging, broadcast, or the like to multiple users. For example, the communication network 12 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. Further, the communication network 12 may comprise other networks such as a core network, the Internet, a sensor network, an industrial control network, a personal area network, a satellite network, a home network, or an enterprise network for example. Any of the client, proxy, or server devices illustrated in any of FIGS. 1, 3 and 6.

The service layer may be a functional layer within a network service architecture. Service layers are typically situated above the application protocol layer such as HTTP, CoAP or MQTT and provide value added services to client applications. The service layer also provides an interface to core networks at a lower resource layer, such as for example, a control layer and transport/access layer. The service layer supports multiple categories of (service) capabilities or functionalities including a service definition, service runtime enablement, policy management, access control, and service clustering. Recently, several industry standards bodies, e.g., oneM2M, have been developing M2M service layers to address the challenges associated with the integration of M2M types of devices and applications into deployments such as the Internet/Web, cellular, enterprise, and home networks. A M2M service layer can provide applications and/or various devices with access to a collection of or a set of the above mentioned capabilities or functionalities, supported by the service layer, which can be referred to as a CSE or SCL. A few examples include but are not limited to security, charging, data management, device management, discovery, provisioning, and connectivity management which can be commonly used by various applications. These capabilities or functionalities are made available to such various applications via APIs which make use of message formats, resource structures and resource representations defined by the M2M service layer. The CSE or SCL is a functional entity that may be implemented by hardware and/or software and that provides (service) capabilities or functionalities exposed to various applications and/or devices (i.e., functional interfaces between such functional entities) in order for them to use such capabilities or functionalities.

As shown in FIG. 5A, the M2M/IoT/WoT communication system 10 includes a communication network 12. The communication network 12 may be a fixed network (e.g., Ethernet, Fiber, ISDN, PLC, or the like) or a wireless network (e.g., WLAN, cellular, or the like) or a network of heterogeneous networks. For example, the communication network 12 may be comprised of multiple access networks that provide content such as voice, data, video, messaging, broadcast, or the like to multiple users. For example, the communication network 12 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. Further, the communication network 12 may comprise other networks such as a core network, the Internet, a sensor network, an industrial control network, a personal area network, a fused personal network, a satellite network, a home network, or an enterprise network for example.

As shown in FIG. 1A, the M2M/IoT/WoT communication system 10 may include the Infrastructure Domain and the Field Domain. The Infrastructure Domain refers to the network side of the end-to-end M2M deployment, and the Field Domain refers to the area networks, usually behind an M2M gateway. The Field Domain and Infrastructure Domain may both comprise a variety of different nodes (e.g., servers, gateways, device, and the like) of the network. For example, the Field Domain may include M2M gateways 14 and devices 18. It will be appreciated that any number of M2M gateway devices 14 and M2M devices 18 may be included in the M2M/IoT/WoT communication system 10 as desired. Each of the M2M gateway devices 14 and M2M devices 18 are configured to transmit and receive signals, using communications circuitry, via the communication network 12 or direct radio link. A M2M gateway 14 allows wireless M2M devices (e.g., cellular and non-cellular) as well as fixed network M2M devices (e.g., PLC) to communicate either through operator networks, such as the communication network 12 or direct radio link. For example, the M2M devices 18 may collect data and send the data, via the communication network 12 or direct radio link, to an M2M application 20 or other M2M devices 18. The M2M devices 18 may also receive data from the M2M application 20 or an M2M device 18. Further, data and signals may be sent to and received from the M2M application 20 via an M2M Service Layer 22, as described below. M2M devices 18 and gateways 14 may communicate via various networks including, cellular, WLAN, WPAN (e.g., Zigbee, 6LoWPAN, Bluetooth), direct radio link, and wireline for example. Exemplary M2M devices include, but are not limited to, tablets, smart phones, medical devices, temperature and weather monitors, connected cars, smart meters, game consoles, personal digital assistants, health and fitness monitors, lights, thermostats, appliances, garage doors and other actuator-based devices, security devices, and smart outlets.

Referring to FIG. 5B, the illustrated M2M Service Layer 22 in the field domain provides services for the M2M application 20, M2M gateways 14, and M2M devices 18 and the communication network 12. It will be understood that the M2M Service Layer 22 may communicate with any number of M2M applications, M2M gateways 14, M2M devices 18, and communication networks 12 as desired. The M2M Service Layer 22 may be implemented by one or more nodes of the network, which may comprise servers, computers, devices, or the like. The M2M Service Layer 22 provides service capabilities that apply to M2M devices 18, M2M gateways 14, and M2M applications 20. The functions of the M2M Service Layer 22 may be implemented in a variety of ways, for example as a web server, in the cellular core network, in the cloud, etc.

Similar to the illustrated M2M Service Layer 22, there is the M2M Service Layer 22′ in the Infrastructure Domain. M2M Service Layer 22′ provides services for the M2M application 20′ and the underlying communication network 12 in the infrastructure domain. M2M Service Layer 22′ also provides services for the M2M gateways 14 and M2M devices 18 in the field domain. It will be understood that the M2M Service Layer 22′ may communicate with any number of M2M applications, M2M gateways and M2M devices. The M2M Service Layer 22′ may interact with a Service Layer by a different service provider. The M2M Service Layer 22′ may be implemented by one or more nodes of the network, which may comprise servers, computers, devices, virtual machines (e.g., cloud computing/storage farms, etc.) or the like.

Referring also to FIG. 5B, the M2M Service Layers 22 and 22′ provide a core set of service delivery capabilities that diverse applications and verticals may leverage. These service capabilities enable M2M applications 20 and 20′ to interact with devices and perform functions such as data collection, data analysis, device management, security, billing, service/device discovery, etc. Essentially, these service capabilities free the applications of the burden of implementing these functionalities, thus simplifying application development and reducing cost and time to market. The Service Layers 22 and 22′ also enable M2M applications 20 and 20′ to communicate through various networks such as network 12 in connection with the services that the Service Layers 22 and 22′ provide.

The M2M applications 20 and 20′ may include applications in various industries such as, without limitation, transportation, health and wellness, connected home, energy management, asset tracking, and security and surveillance. As mentioned above, the M2M Service Layer, running across the devices, gateways, servers and other nodes of the system, supports functions such as, for example, data collection, device management, security, billing, location tracking/geofencing, device/service discovery, and legacy systems integration, and provides these functions as services to the M2M applications 20 and 20′.

Generally, a Service Layer, such as the Service Layers 22 and 22′ illustrated in FIG. 5B, defines a software middleware layer that supports value-added service capabilities through a set of Application Programming Interfaces (APIs) and underlying networking interfaces. Both the ETSI M2M and oneM2M architectures define a Service Layer. ETSI M2M's Service Layer is referred to as the Service Capability Layer (SCL). The SCL may be implemented in a variety of different nodes of the ETSI M2M architecture. For example, an instance of the Service Layer may be implemented within an M2M device (where it is referred to as a device SCL (DSCL)), a gateway (where it is referred to as a gateway SCL (GSCL)) and/or a network node (where it is referred to as a network SCL (NSCL)). The oneM2M Service Layer supports a set of Common Service Functions (CSFs) (i.e., service capabilities). An instantiation of a set of one or more particular types of CSFs is referred to as a Common Services Entity (CSE) which may be hosted on different types of network nodes (e.g., infrastructure node, middle node, application-specific node). The Third Generation Partnership Project (3GPP) has also defined an architecture for machine-type communications (MTC). In that architecture, the Service Layer, and the service capabilities it provides, are implemented as part of a Service Capability Server (SCS). Whether embodied in a DSCL, GSCL, or NSCL of the ETSI M2M architecture, in a Service Capability Server (SCS) of the 3GPP MTC architecture, in a CSF or CSE of the oneM2M architecture, or in some other node of a network, an instance of the Service Layer may be implemented as a logical entity (e.g., software, computer-executable instructions, and the like) executing either on one or more standalone nodes in the network, including servers, computers, and other computing devices or nodes, or as part of one or more existing nodes. As an example, an instance of a Service Layer or component thereof may be implemented in the form of software running on a network node (e.g., server, computer, gateway, device or the like) having the general architecture illustrated in FIG. 5C or FIG. 5D described below.

Further, the methods and functionalities described herein may be implemented as part of an M2M network that uses a Service Oriented Architecture (SOA) and/or a Resource-Oriented Architecture (ROA) to access services.

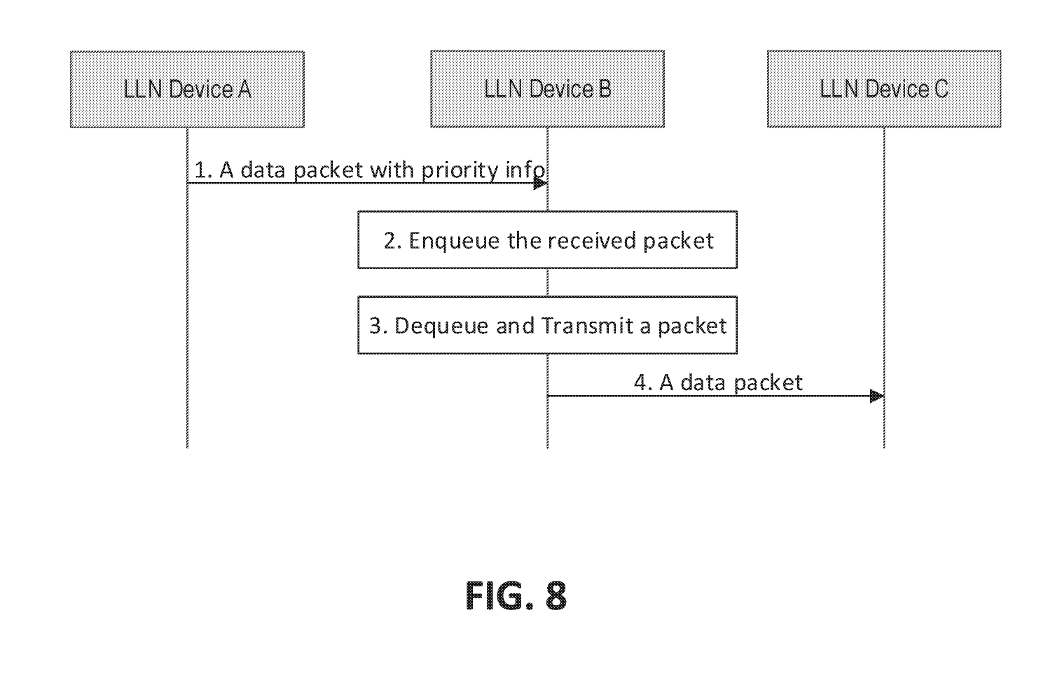

FIG. 5C is a block diagram of an example hardware/software architecture of a node of a network, such as one of the clients, servers, or proxies illustrated in FIGS. 1 and 3, which may operate as an M2M server, gateway, device, or other node in an M2M network such as that illustrated in FIGS. 1 and 3. As shown in FIG. 1C, the node 30 may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The node 30 may also include communication circuitry, such as a transceiver 34 and a transmit/receive element 36. It will be appreciated that the node 30 may include any sub-combination of the foregoing elements while remaining consistent with an embodiment. This node may be a node that implements methods of transmitting packets, e.g., in relation to the methods described in reference to FIGS. 8-13 and 16, Tables 2-18, or in a claim.

The processor 32 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

As shown in FIG. 5C, the processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected. In particular, the processor 32 may control the communication circuitry in order to perform the methods of transmitting packets herein, e.g., in relation to FIGS. 8-13 and 16, or in a claim. While FIG. 5C depicts the processor 32 and the transceiver 34 as separate components, it will be appreciated that the processor 32 and the transceiver 34 may be integrated together in an electronic package or chip.

The transmit/receive element 36 may be configured to transmit signals to, or receive signals from, other nodes, including M2M servers, gateways, device, and the like. For example, in an embodiment, the transmit/receive element 36 may be an antenna configured to transmit and/or receive RF signals. The transmit/receive element 36 may support various networks and air interfaces, such as WLAN, WPAN, cellular, and the like. In an embodiment, the transmit/receive element 36 may be an emitter/detector configured to transmit and/or receive IR, UV, or visible light signals, for example. In yet another embodiment, the transmit/receive element 36 may be configured to transmit and receive both RF and light signals. It will be appreciated that the transmit/receive element 36 may be configured to transmit and/or receive any combination of wireless or wired signals.

In addition, although the transmit/receive element 36 is depicted in FIG. 5C as a single element, the node 30 may include any number of transmit/receive elements 36. More specifically, the node 30 may employ MIMO technology. Thus, in an embodiment, the node 30 may include two or more transmit/receive elements 36 (e.g., multiple antennas) for transmitting and receiving wireless signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple RATs, such as UTRA and IEEE 802.11, for example.

The processor 32 may access information from, and store data in, any type of suitable memory, such as the non-removable memory 44 and/or the removable memory 46. For example, the processor 32 may store session context in its memory, as described above. The non-removable memory 44 may include random-access memory (RAM), read-only memory (ROM), a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the node 30, such as on a server or a home computer. The processor 32 may be configured to control lighting patterns, images, or colors on the display or indicators 42 to reflect the status of an M2M Service Layer session migration or sharing or to obtain input from a user or display information to a user about the node's session migration or sharing capabilities or settings. In another example, the display may show information with regard to a session state.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which is configured to provide location information (e.g., longitude and latitude) regarding the current location of the node 30. It will be appreciated that the node 30 may acquire location information by way of any suitable location-determination method while remaining consistent with an embodiment.

The processor 32 may further be coupled to other peripherals 52, which may include one or more software and/or hardware modules that provide additional features, functionality and/or wired or wireless connectivity. For example, the peripherals 52 may include various sensors such as an accelerometer, biometrics (e.g., finger print) sensors, an e-compass, a satellite transceiver, a sensor, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The node 30 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The node 30 may connect to other components, modules, or systems of such apparatuses or devices via one or more interconnect interfaces, such as an interconnect interface that may comprise one of the peripherals 52.

FIG. 5D is a block diagram of an exemplary computing system 90 which may also be used to implement one or more nodes of a network, such as the clients, servers, or proxies illustrated in FIGS. 1 and 3 which may operate as an M2M server, gateway, device, or other node in an M2M network such as that illustrated in FIGS. 1 and 3. Computing system 90 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 90 to do work. In many known workstations, servers, and personal computers, central processing unit 91 is implemented by a single-chip CPU called a microprocessor. In other machines, the central processing unit 91 may comprise multiple processors. Coprocessor 81 is an optional processor, distinct from main CPU 91, that perform additional functions or assists CPU 91. CPU 91 and/or coprocessor 81 may receive, generate, and process data related to the disclosed systems and methods for E2E M2M Service Layer sessions, such as receiving session credentials or authenticating based on session credentials.

In operation, CPU 91 fetches, decodes, and executes instructions, and transfers information to and from other resources via the computer's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a network adaptor 97, that may be used to connect computing system 90 to an external communications network, such as network 12 of FIGS. 5A-D, to enable the computing system 90 to communicate with other nodes of the network.

### Interface Queue Model

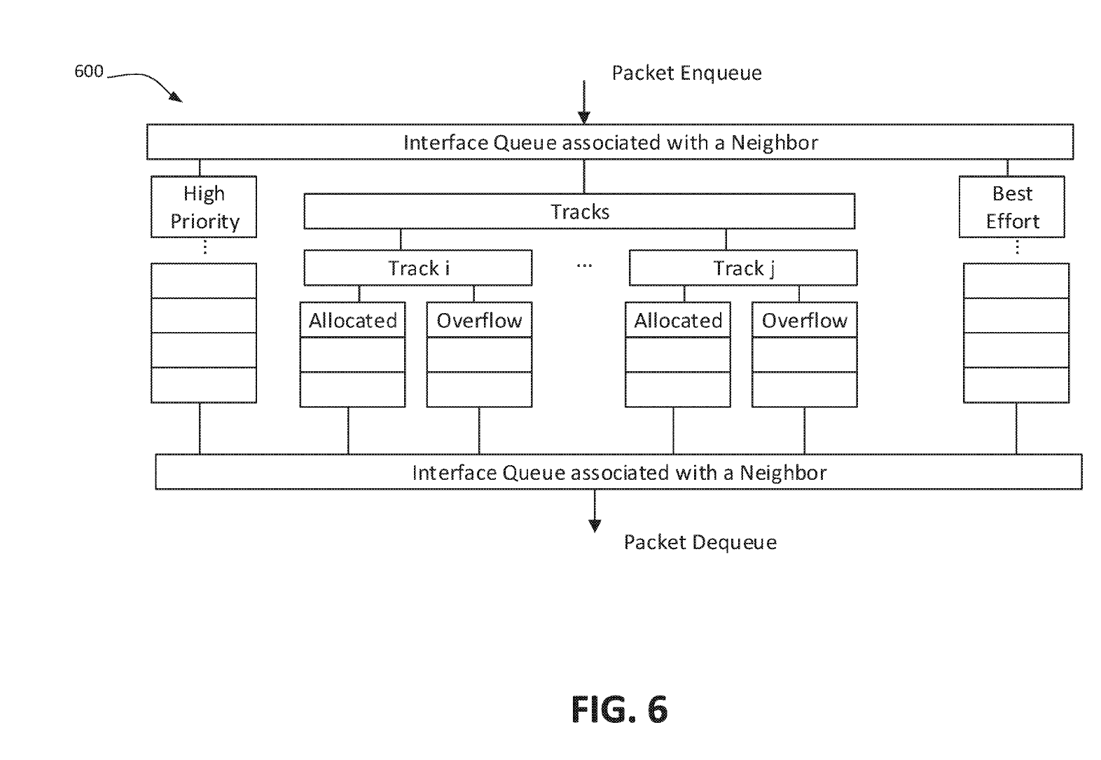

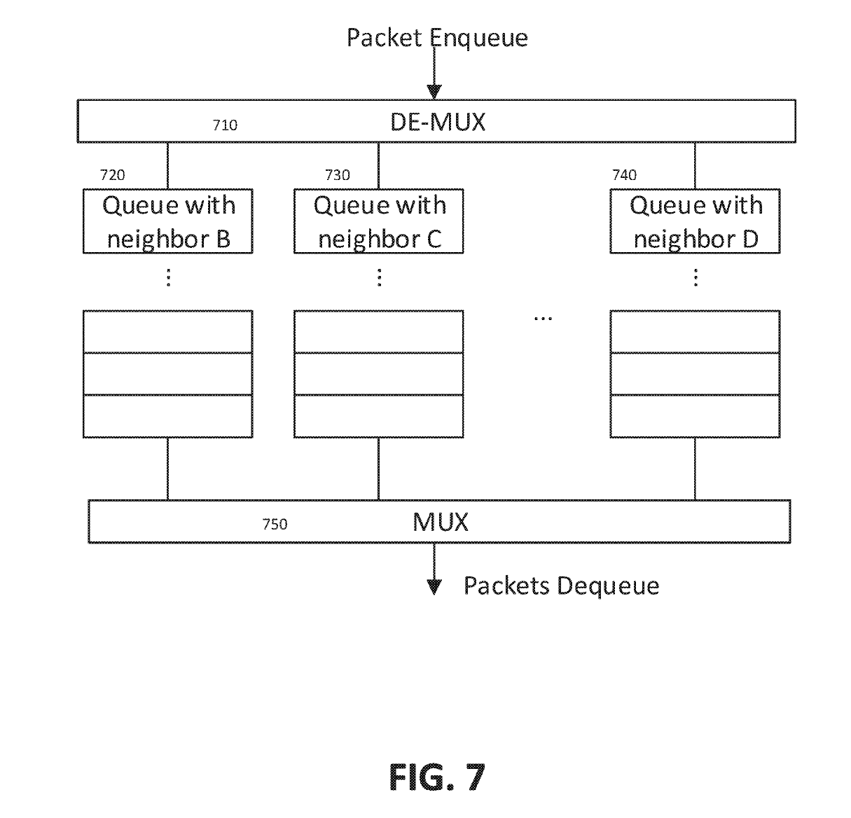

According to an aspect of the application, a queue model is envisaged to manage traffic with different priorities. One embodiment of the queue model 600 for a LLN device is exemplarily shown in FIG. 6. In another embodiment, as shown in FIG. 7, an interface queue of the queue model 600 is associated with each one-hop neighbor of an LLN device. For example, LLN device A may have three neighbors—LLN devices B, C and D—with respective interface queues 720, 730 and 740. These interface queues are connected to a demultiplexer 710 and a multiplexer 750. A packet is enqueued through a demultiplexer (DE-MUX) 710 and dequeued via a multiplexer 750.

In another embodiment, each interface queue contains a subqueue for high priority traffic, i.e., Q_high, a subqueue for best effort traffic and several subqueues associated with tracks. Each subqueue associated with a track also contains an allocated queue, i.e., Q_allocated, and an overflow queue, i.e., Q_overflow. The maximum size of the allocated queue equals the number of cells reserved by the track. The overflow queue contains packets associated with the track if the allocated queue is full. The length of the overflow queue, high priority queue and best effort queue are determined based upon the size of packets in the queue. The maximum size of an overflow queue, high priority queue and best effort queue are determined based on the memory size of a LLN device. Packets will be discarded if no allocated memory is available to store new packets. An LLN device may also periodically monitor the length of an interface queue. For example, an LLN device may obtain the instantaneous length of the queue several times during a slotframe following a pre-defined interval, and then calculate the average length of the queue at the end of a slotframe. Based on the average length of the queue, an LLN device may adjust the size of the bundle.

According to an aspect of the application, two procedures are proposed for enqueue and dequeue operations. As shown in FIG. 8, when LLN device B receives a packet from LLN device A, it will extract the priority and track information contained in the packet. In one implementation, the priority and track information can be embedded in the IE field of the MAC frame as shown in TABLE 7. As an example, the priority information can be one bit field to indicate whether the priority of the packet is high or low. Then, LLN device B inserts the packet into one of the sub-queues in the interface queue based on the priority information. Then, when LLN device B is in a transmitting cell, it dequeues a packet from the interface queue, inserts the priority and track information in the IE field and transmits the packet.

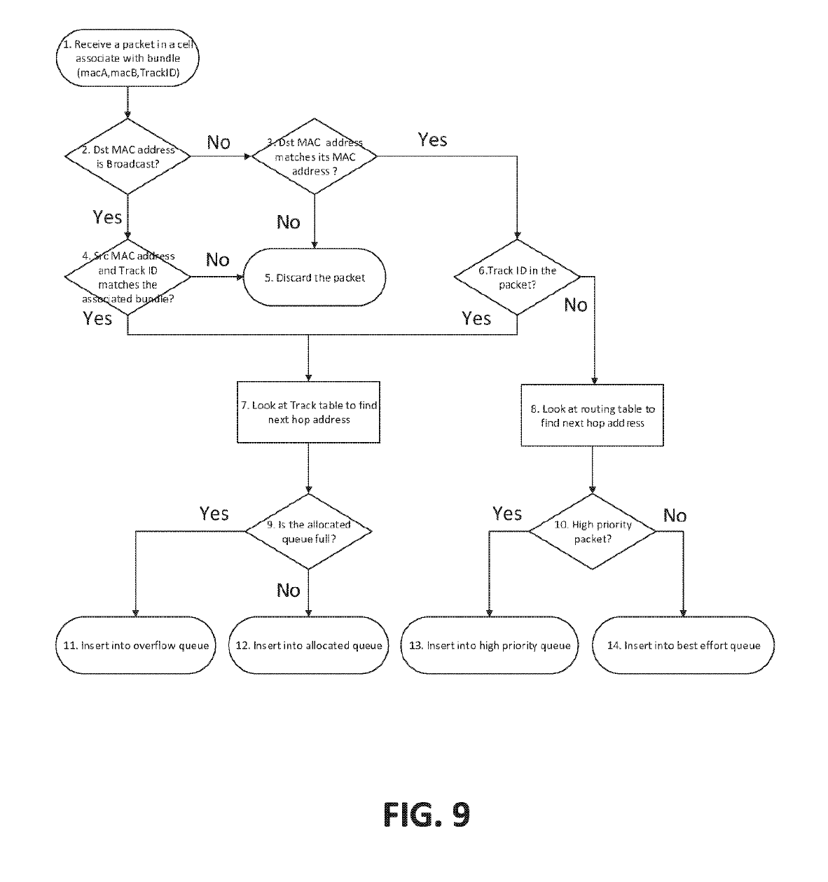

In an embodiment, a LLN device enqueues a received packet as shown by the flowchart illustrated in FIG. 9. The procedure puts packets with different priorities into different sub-queues. As a result, packets with different priorities can be managed. According to Step 1, the LLN device, e.g., LLN device B, receives a packet from another LLN device, e.g., LLN device A. LLN device B has to be in a scheduled receiving cell associated with bundle (macA,macB,TrackID) in order to receive a packet from LLN device A. The scheduled receiving cell may be associated with a track, which is from the source LLN device S to a destination LLN device D. The receiving cell may also belong to a per hop bundle (macA, macB, NULL) that is from LLN device A to LLN device B, where MacA and MacB are the MAC layer addresses of LLN device A and B respectively.

Next, in Step 2, LLN device B will check whether the Destination (Dst) Address in the MAC layer frame is a broadcast address. If the Dst address is not a broadcast address, LLN device B proceeds to Step 3. If the Dst address is a broadcast address, LLN device B proceeds to Step 4.

According to Step 3, LLN device B will check whether the Dst Address is the same as its own MAC address. If the two addresses are different, LLN device B proceeds to Step 5. This is because it is not a packet that is destined to it. Alternatively, LLN device B proceeds to Step 6 if the Dst MAC address matches its MAC address.

According to Step 4, LLN device B will do a simple check whether the Source Address in the MAC layer frame and the track ID match the information of the bundle associated with the particular cell. If it is a match, the LLN device proceeds to Step 7 to further process the packet. If it is not a match, the LLN device will proceed to Step 5. In Step 5, the LLN device B will discard the packet since LLN device B is not an intended receiver of the packet.

According to Step 6, the LLN device B will check if there is a track ID associated with the packet. If the packet is associated with a Track, it proceeds to step 7.

According to Step 7, the LLN device B will find the next hop of the packet based on TrackID. The LLN device will then insert the packet into the interface queue associated with the next hop neighbor. The process continues to Step 9. In Step 9, the LLN device B will check if the allocated queue associated with the Track is full. If the allocated queue is full, the packet is inserted into the overflow queue (Step 11). If the allocated queue is not full, the packet is inserted into the allocated queue (Step 12). Packets will be discarded if there is no memory to be allocated to store new packets.

Alternatively if the track ID is not associated with the packet in Step 6, the process proceeds to Step 8. In Step 8, the LLN device B will find the next hop of the packet based on routing table. For example, LLN device B can use the routing table to find the next hop address. Next, the LLN device B will check the priority property of the packet (Step 10). If the packet is determined to be high priority, the packet is inserted into a high priority queue (Step 13). If the packet is not determined to be high priority, the packet is inserted into a best effort queue (Step 14). Packets will be discarded if there is no memory to be allocated to store new packets.

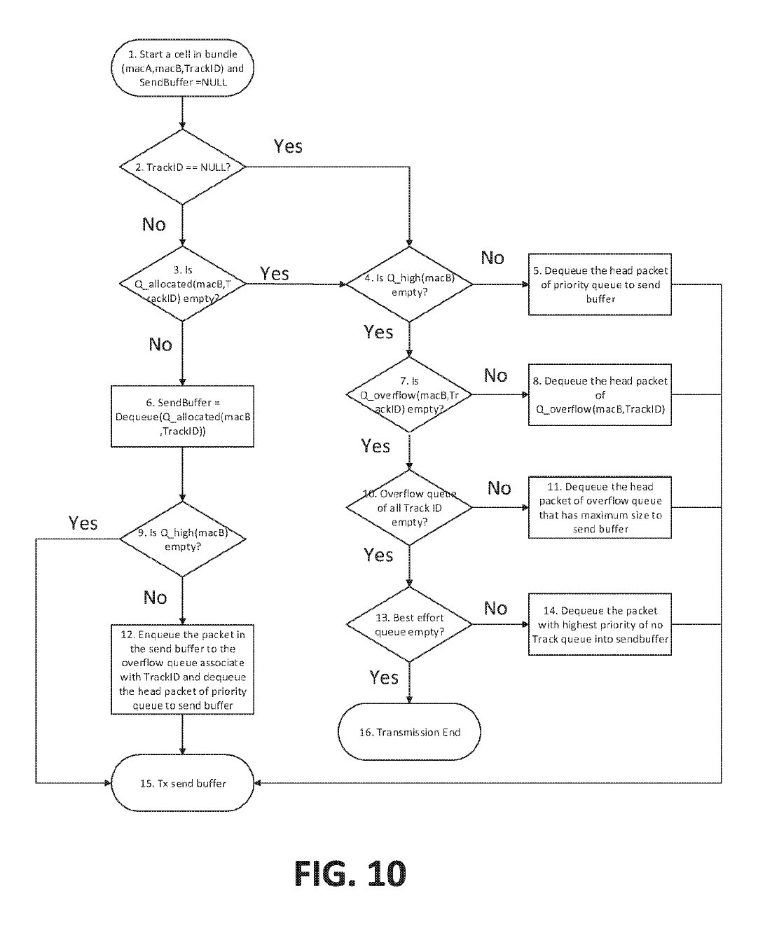

According to another aspect of the application, a technique and system is described wherein LLN devices process a cell that is scheduled to transmit a packet. FIG. 10 illustrates an exemplary flowchart for a LLN device to dequeue a packet. Namely the LLN device dequeues the packet in the SendBuffer. The SendBuffer is a location to store the packet to be transmitted by the radio. In so doing, the procedure allows packets associated with high priority traffic to be transmitted first, or before other traffic, and also balances the traffic load associated with different tracks.

According to Step 1, a LLN device, such as for example, LLN device B with MAC address macB, is in a cell scheduled to transmit a packet to another LLN device. The receiving LLN device may be device C with MAC address macC. That is, the scheduled cell is associated with a bundle (macB, macC, TrackID). At the end of the procedure, LLN device B will send the next packet in the “SendBuffer” if it is not equal to “NULL”.

Since there are two types of bundles, the LLN device is required to identify the bundle type by checking its TrackID field (Step 2). A TrackID that is not equal to NULL, i.e., “No” response, indicates that the bundle is a layer 2 bundle associated with a track of the LLN device. Alternatively, if Track ID equals to NULL, i.e., “Yes” response, this is an indication the bundle is a layer 3 bundle and proceeds with processing to Step 4.

In Step 3, i.e., “No” response to Step 2, LLN device B checks the interface queue that is associated with LLN device C. In the interface queue, if the allocated queue associated with the track, i.e., Q_allocated (macC, TrackID), is not empty, i.e., “No”, LLN device B proceeds to Step 6. In Step 6, LLN device B will dequeue the head-of-queue of the allocated associated with the track, and assign it to the “SendBuffer.” Processing will continue to Step 9.

According to Step 9, LLN device B checks the interface queue that is associated with LLN device C. In the interface queue, if the high priority queue is empty, i.e., “Yes” response, processing continues to Step 15 for transmission of send buffer. Otherwise, processing continues to Step 12. In Step 12, LLN device B will enqueue the packet in the “SendBuffer” to the overflow queue associated with TrackID and dequeue the head-of-queue of priority queue to the “SendBuffer”. Then processing continues to Step 15 for transmission of send buffer.

According to another embodiment, if the response to the query in Step 3 is “Yes,” processing continues to Step 4. In Step 4, LLN device B checks the interface queue that is associated with LLN device C. If the response to the query in Step 4 is “No,” processing continues to Step 5. In Step 5, LLN device B will dequeue the head-of-queue of the high priority queue and assign it to the “SendBuffer”. Then, processing continues to Step 15 to send the packet in the “SendBuffer”. Alternatively, if the high priority queue, i.e., Q_high (macC, TrackID), is empty, i.e., “Yes” response to query in Step 4, processing continues to Step 7.

In Step 7, LLN device B checks the interface queue that is associated with LLN device C. In the interface queue, if the overflow queue associated with the track, i.e. Q_overflow (macC, TrackID), is not empty, i.e., “No” response, LLN device B continues to step 8. In Step 8, LLN device B will dequeue the head-of-queue of the overflow queue associated with the track. The LLN device will assign it to the “SendBuffer”, and then proceed Step 15 for transmission.

Alternatively, if the response to the query in Step 7 is “Yes,” processing continues to Step 10. In Step 10, LLN device B checks the interface queue that is associated with LLN device C. If the overflow queue of all Track IDs is not empty, the LLN device B will dequeue the head-of-queue of the overflow queue associated with a selected track and assign it the “SendBuffer” (Step 11). In this determination, there may be multiple policies for selecting the track. For example, the LLN device can select the track that has the maximum queue length. Alternatively, LLN device can select the track that has not been selected for the longest time. Subsequently, there is a transmission of the packet from the “SendBuffer” (Step 15).

Alternatively, if all of the overflow queues associated with other tracks are empty, i.e., “Yes” response, the process proceeds to Step 13. In Step 13, LLN device B checks the interface queue that is associated with LLN device C. In the interface queue, if the best effort queue is empty, processing proceeds to Step 16 in which the LLN device B does not have a packet to transmit. As a result, dequeue processing ends. Otherwise, it proceeds to Step 14. In Step 14, LLN device B will dequeue the head-of-queue of the best effort queue and assign it the “SendBuffer”. Then, LLN device proceeds to step 15 wherein the LLN device B transmits the packet in the SendBuffer.

According to yet another aspect of the application, the size of the bundle is dynamically adjusted to most efficiently use the resources of the network. For example, if the size of the bundle is much bigger than the traffic demand, some scheduled cells will remain idle. These unused resources associated with the bundle decrease the free capacity of the network and need to be released. On the other hand, if the size of the bundle is much smaller than the traffic demand, the latency for the traffic will be increased. As a result, more resources need to be reserved for the Bundle.

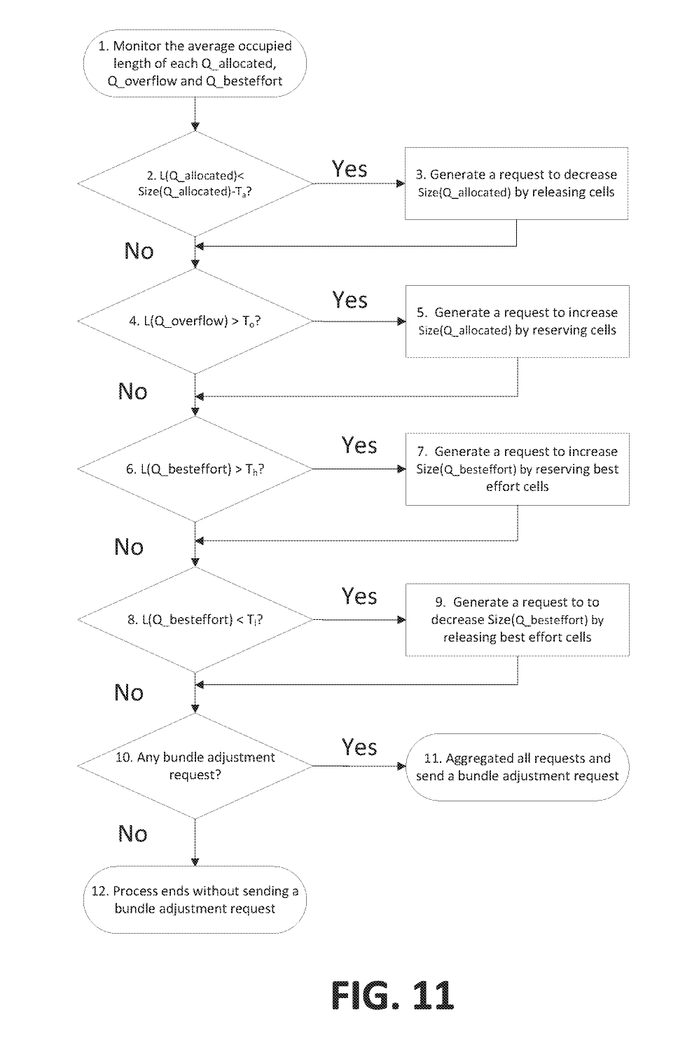

In an embodiment, each LLN device will monitor the length of each queue. This may occur periodically, for example, at the beginning of each slot frame. The bundle adjustment procedure can be triggered if the length of an allocated queue L(Q_allocated), the length of an overflow queue L(Q_overflow) or the length of a best effort queue L(Q_besteffort) meets the requirement, e.g., Steps 2/4/6/8, as exemplarily shown in FIG. 11. Generally, a bundle adjustment procedure will be triggered if the length of a queue is bigger than a predefined threshold.

According to Step 1, a LLN device will periodically monitor the length of each allocated queue L(Q_allocated), the length of each overflow queue L(Q_overflow) and the length of each best effort queue L(Q_besteffort). In Step 2, the LLN device will check whether the average length of the allocated queue L(Q_allocated) is smaller than the size of the associated bundle Size(Q_allocated) minus a threshold value Tₐ. The value of Tₐ can be configured by an LLN device. In general, Tₐ is smaller if the LLN device has limited memory resources and a smaller Tₐ will trigger more bundle adjustment procedures. If the response to Step 2 is “Yes,” the process will continue to Step 3. In Step 3, the LLN device will generate a request to decrease the bundle size associated with the queue by releasing one or more cells, e.g., (Size (Q_allocated)-L (Q_allocated)) number of cells. The process then continues to Step 4.

Alternatively, if the response to the query in Step 2 is “No,” the process will proceed to Step 4. In Step 4, the LLN device will check whether the average length of the overflow queue L(Q_overflow) is bigger than a threshold value Tₒ. If “Yes,” the process will go to Step 5 where the LLN device will generate a request to increase the bundle size associated with the queue by reserving one or more cells. Then, the process proceeds to Step 6.

In an embodiment, the value of Tₒ can be configured by an LLN device. In general, Tₒ is smaller if the LLN device has limited memory resources. A smaller Tₒ will trigger more bundle adjustment procedures.

If the reply to the query in step 4 is “No,” the process proceeds to Step. Here, the LLN device will check whether the average length of the best effort queue L(Q_besteffort) is bigger than a threshold value Tₕ (Step 6). If the answer is “Yes,” it will go to Step 7. In Step 7, LLN device will generate a request to increase the bundle size of the best effort traffic by reserving one or more cells, and then proceed to Step 8.

If the answer is “No,” the process will go to Step 8. Here the value of Tₕ can be configured by an LLN device. In Step 8, the LLN device will check whether the average length associated the best effort queue L(Q_besteffort) is smaller than a threshold value Tₗ. In general, Tₕ is smaller if the LLN device has limited memory resources and a smaller Tₕ will trigger more bundle adjustment procedures.

If the answer to the query in Step 8 is “Yes,” the process will go to Step 9. In Step 9, the LLN device will generate a request to decrease the bundle size associated with the best effort traffic by releasing one or more cells. The process then proceeds to Step 10. If the answer to the query in Step 8 is “No,” the process proceeds to Step 10. In Step 10, the LLN device will check whether there is one or more bundle adjustment requests generated during the process. The value of Tl can be configured by an LLN device. In general, T₁ is smaller if the LLN device has limited memory resources and a smaller T₁ will trigger more bundle adjustment procedures.

If the answer to the query in Step 10 is “Yes,” the process continues to Step 11, wherein the LLN will aggregate all the generated requests and send an aggregated bundle adjustment request that contains multiple requests for different bundles. The transmitting process ends and the LLN device awaits a response. If the answer to the query in Step 10 is “No,” the process continues to Step 12 whereby the process does not send a bundle adjustment request.

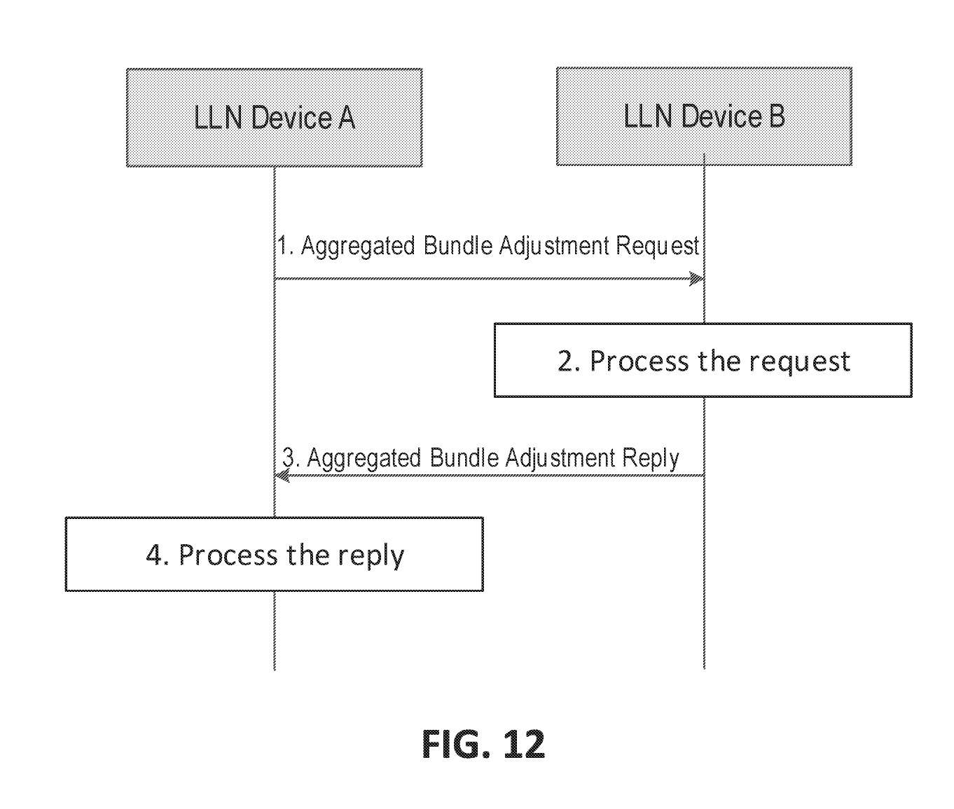

According to an embodiment, a bundle adjustment procedure is envisaged between two LLN devices. This is exemplarily illustrated in FIG. 12. In Step 1, LLN device A sends an Aggregated Bundle Adjustment Request message to LLN device B. The Aggregated Bundle Adjustment Request messages may contain several bundle adjustment requests generated by device A. The Bundle Adjustment Request message may include but is not limited to the fields in TABLE 7 shown below.

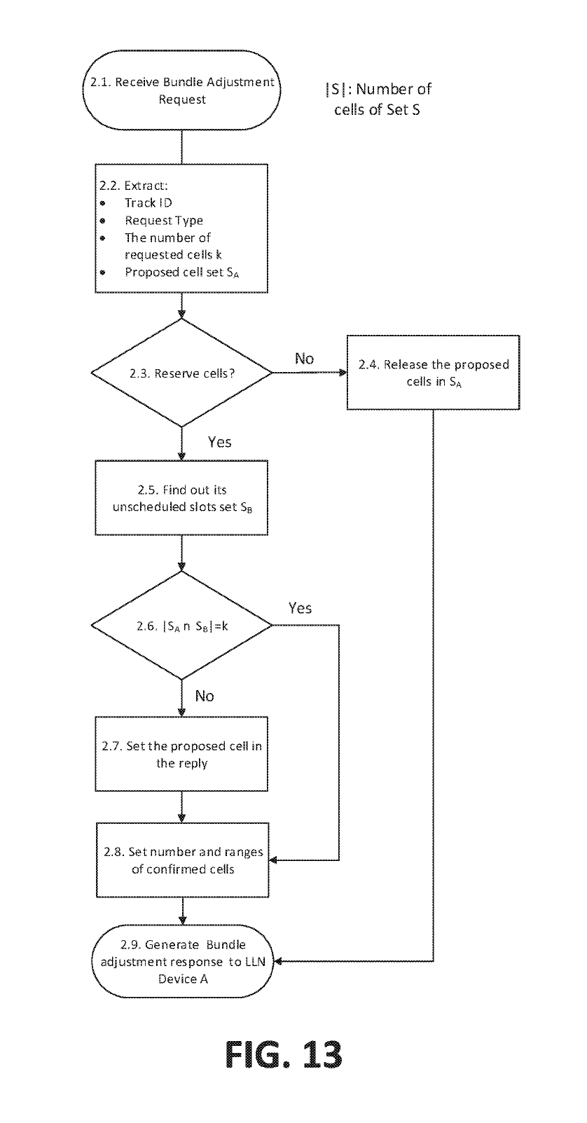

In Step 2, the LLN device B processes the Aggregated Bundle Adjustment Request from LLN device A. LLN device B will process each Bundle Adjustment Requests in the message to check if it can allocate Soft Cells for LLN device A. The procedures of Step 2 that follow are exemplarily shown in FIG. 13.

Specifically in Step 2.1, LLN device B receives the Bundle Adjustment Request. In Step 2.2, LLN device B extracts the following information received from the Bundle Adjustment Request message including but not limited to: Track ID: Request type; the number of requested cells k; and proposed cell set SA. In Step 2.3, the LLN device B checks the type of the request. Depending upon the request, the LLN device B either (i) requests to release cells (Step 2.4) or (ii) determines it unscheduled slot set S_{B} (Step 2.5).

Next, the LLN device B checks the number of unscheduled cells that are overlapped with unscheduled cells of LLN device A, i.e., |S_{A}∩S_{B}| (Step 2.6). If |S_{A}∩S_{B}| is larger than the requested slots k, LLN device B proceeds to Step 2.8 where it sets the number and ranges of confirmed cell. If lower, the LLN device proceeds to Step 2.7 where it proposes some of its unscheduled cells to LLN device A. In Step 2.9, LLN device B generates the bundle adjustment reply message back to LLN device A.

Subsequently LLN device B sends a Bundle Adjustment Reply message to LLN device A (Step 3). The Bundle Adjustment Reply message may include but is not limited to fields in TABLE 10. Thereafter, LLN device A processes the Aggregated Bundle Adjustment Reply message it received (Step 4). If the number of confirmed cells is smaller than the number of requested cells, LLN device A will generate another Bundle Adjustment Request and then send an Aggregated Bundle Adjustment Request message to LLN device B again until it reaches the maximum number of retries that is configurable.

TABLE 7

| Fields name | Description |
|---|---|
| Transmitter Address | The IP/MAC address of the LLN device that |
| | sends Bundle Adjustment Request. |
| Receiver Address | The IP/MAC address of the LLN devices that |
| | receives Track Adjustment Request. |
| Bundle Adjustment | The information of the first Bundle Adjustment |
| Request 1 | Request, the detail information in a Bundle |
| | Adjustment Request is described in TABLE 8. |
| Bundle Adjustment | The information of the second Bundle Adjustment |
| Request 2 | Request, the detail information in a Bundle |
| | Adjustment Request is described in TABLE 8. |
| . . . | |
| Bundle Adjustment | The information of the nth Bundle Adjustment |
| Request n | Request, the detail information in a Bundle |
| | Adjustment Request is described in TABLE 8. |

TABLE 8

| | |
|---|---|
| Track ID | The Track ID associated with the bundle to be adjusted. The value |
| | is NULL if the bundle is a layer 3 bundle. |
| Request Type | Indicate the type of the request. There are two type of request. One |
| | is employed to increase and the other one is employed to decrease |
| | the size of the bundle. As an example, the value set to 1 indicates it |
| | is a request to increase the bundle size. The value set to 2 indicates |
| | it is a request to decrease the bundle size. |
| Number of requested | The number of cells that is requested to reserve or release |
| cells | |
| Range of proposed cells | This field contains proposed cells by the transmitter to reserve or |
| | release. In particular, to reserve cells, it contains the range of all |
| | unscheduled cell of the transmitter that can be reserved for the |
| | receiver. To release cells, it contains the range of cell that can be |
| | released. In one implementation, this field can list the slot offset of |
| | all proposed cells. In another implementation, this field can list the |
| | slot offset of the first cell of the range and number of consecutive |
| | cells proposed. In yet another implementation, this field can list |
| | the slot offset of the first and last cell of the range proposed. |

TABLE 9

| Fields name | Description |
|---|---|
| Transmitter Address | The IP/MAC address of the source LLN |
| | device that sends Bundle Assignment Reply |
| Receiver Address | The IP/MAC address of the LLN devices |
| | on the track that receives Bundle Assignment Reply |
| Bundle Adjustment | The information of the first Bundle Adjustment |
| Response 1 | Response, the detail information in a Bundle |
| | Adjustment Response is described in TABLE 10. |
| Bundle Adjustment | The information of the second Bundle |
| Response 2 | Adjustment Response, the detail information in a |
| | Bundle Adjustment Response is described in |
| | TABLE 10. |
| . . . | |
| Bundle Adjustment | The information of the nth Bundle Adjustment |
| Response n | Response, the detail information in a Bundle |
| | Adjustment Response is described in TABLE 10 |

TABLE 10

| | |
|---|---|
| Track ID | The Track ID associated with the bundle to be adjusted. If the |
| | value is NULL then the bundle is a layer 3 bundle. |
| Decision | The decision of the bundle adjustment. The value is true if the |
| | transmitter has unscheduled slots that meet the request and is false |
| | otherwise. |
| Number of confirmed | The number of cells that is confirmed to be reserved or released |
| cells | |
| Range of confirmed cells | This field contains confirmed cells by the receiver to reserve or |
| | release. In particular, to reserve cells, it contains the range of all |
| | unscheduled cell of the receiver that can be reserved for the |
| | transmitter. To release cells, it contains the range of cell that can |
| | be released. In one implementation, this field can list the slot offset |
| | of all confirmed cells. In another implementation, this field can list |
| | the slot offset of the first cell of the range and number of |
| | consecutive cells confirmed. In yet another implementation, this |
| | field can list the slot offset of the first and last cell of the range |
| | confirmed. |
| Range of proposed cells | This field contains proposed cells by the receiver to reserve or |
| (optional) | release. In particular, to reserve cells, it contains the range of all |
| | unscheduled cell of the receiver that can be reserved for the |
| | transmitter. To release cells, it contains the range of cell that can |
| | be released. In one implementation, this field can list the slot offset |
| | of all proposed cells. In another implementation, this field can list |
| | the slot offset of the first cell of the range and number of |
| | consecutive cells proposed. In yet another implementation, this |
| | field can list the slot offset of the first and last cell of the range |
| | proposed. |

According to the present application, it is understood that any or all of the systems, methods and processes described herein may be embodied in the form of computer executable instructions, e.g., program code, stored on a computer-readable storage medium which instructions, when executed by a machine, such as a computer, server, M2M terminal device, M2M gateway device, transit device or the like, perform and/or implement the systems, methods and processes described herein. Specifically, any of the steps, operations or functions described above may be implemented in the form of such computer executable instructions. Computer readable storage media includes volatile and nonvolatile, removable and non-removable media implemented in any method or technology for storage of information, but such computer readable storage media do not includes signals. Computer readable storage media include, but are not limited to, RAM, ROM, EEPROM, flash memory or other memory technology, CD ROM, digital versatile disks (DVD) or other optical disk storage, magnetic cassettes, magnetic tape, magnetic disk storage or other magnetic storage devices, or any other physical medium which can be used to store the desired information and which can be accessed by a computer.

According to yet another aspect of the application, a non-transitory computer-readable or executable storage medium for storing computer-readable or executable instructions is disclosed. The medium may include one or more computer-executable instructions such as disclosed above in the plural call flows according to FIGS. 8-13 and 16. The computer executable instructions may be stored in a memory and executed by a processor disclosed above in FIGS. 5C and 5D, and employed in devices including BRs and LLN device. In one embodiment, a computer-implemented device having a non-transitory memory and processor operably coupled thereto, as described above in FIGS. 5C and 5D, is disclosed. Specifically, the non-transitory memory may include an interface queue that stores a packet for a neighbor device. The interface queue may having subqueues including, for example, a high priority subqueue, a track subqueue, and a best effort subqueue. Moreover, processor may be configured to perform the instructions of determining which of the subqueues to store the packet.

In another embodiment, the non-transitory memory may include an interface queue designated for a neighboring device and have instructions stored thereon for enqueuing a received packet. The processor may be configured to perform a set of instructions including but not limited to: (i) receiving the packet in a cell from the neighboring device; (ii) checking whether a track ID is in the received packet; (iii) checking a table stored in the memory to find a next hop address; and inserting the packet into a subqueue of the interface queue.

In yet another embodiment, the non-transitory memory may include an interface queue designated for a neighboring device and instructions stored thereon for dequeuing a packet. The processor may be configured to perform a set of instructions including but not limited to: (i) evaluating whether the packet in a cell should be transmitted to the neighboring device; (ii) determining whether a high priority subqueue of the interface queue is empty; (iii) dequeuing the packet; and (iv) transmitting the packet to the neighboring device.

In a further embodiment, the non-transitory memory includes an interface queue with a subqueue for a neighboring device, and having instructions stored thereon for adjusting a bundle of the device in the network. The processor may be configured to perform a set of instructions including but not limited to: (i) monitoring the length of the subqueue of the device; (ii) determining the difference between the subqueue and a threshold value; (iii) generating a bundle adjustment request to adjust the size of the subqueue; and (iv) sending the bundle adjustment request to the device.

In yet even a further embodiment, the non-transitory memory includes an interface queue with a subqueue for a neighboring device, and having instructions stored thereon for processing a bundle adjustment request from the neighboring device. The processor may be configured to perform a set of instructions including but not limited to: (i) receiving a bundle adjustment request; (ii) extracting the requested information; (iii) generating a response in view of the extracted information; and (iv) transmitting a response to the device.

### REAL-LIFE EXAMPLES

The above-mentioned application may be useful in real-life situations. For example, the 6TiSCH control messages used within 6TiSCH network can be carried by ICMPv6 messages. Namely, a 6TiSCH control message consists of an ICMPv6 header followed by a message body as discussed above. A 6TiSCH control message can be implemented as an ICMPv6 information message with a Type of 159. The code field identifies the type of 6TiSCH control message as shown in TABLE 11 below. The fields of each message as shown in previous TABLES 7-10 are in the corresponding ICMPv6 message payload.

TABLE 11

| Code | Message |
|---|---|
| 0x01 | Bundle Adjustment Request Message |
| 0x02 | Bundle Adjustment Reply Message |

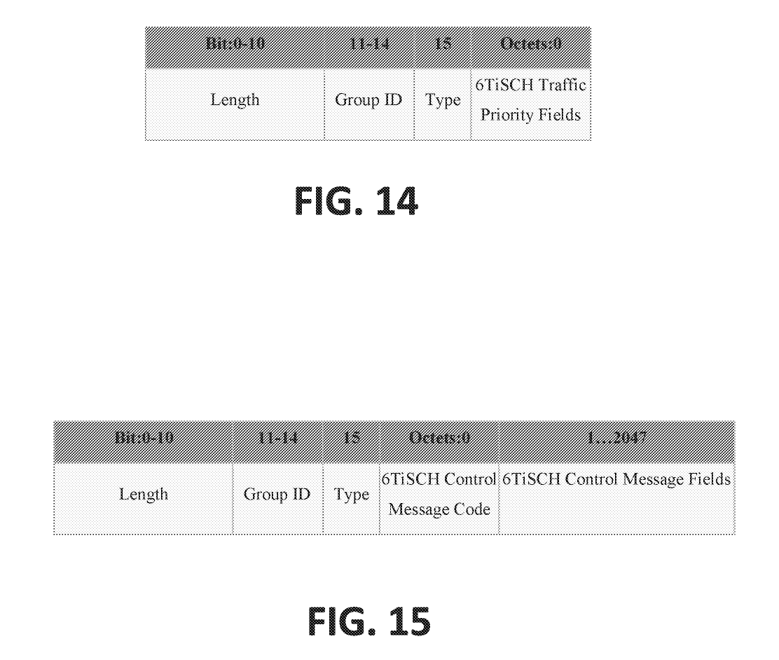

In an embodiment, the proposed 6TiSCH Traffic Priority information can be carried by 802.15.4e header as payload Information Elements. The format of a 6TiSCH Traffic Priority IE is captured in FIG. 14. The fields in 6TiSCH Traffic Priority IE are described in TABLE 12.

TABLE 12

| Fields name | Description |
|---|---|
| Length | The length of the IE |
| Group ID | The Group ID can be set as an unreserved value |
| | between 0x2-0x9, e.g. 0x2. |
| T | Set to 1 to indicate this is a long format packet |
| 6TiSCH Traffic | This field indicates the Priority of the 6TiSCH |
| Priority Fields | control messages. For example, the field set to 1 |
| | indicates this is high priority traffic. |

The 6TiSCH control messages described above can be carried by 802.15.4e header as payload Information Elements, if the destination of the message is one hop away from the sender. The format of a 6TiSCH Control IE is captured in FIG. 15. The fields in 6TiSCH Control IE are described in TABLE 13.

TABLE 13

| Fields name | Description |
|---|---|
| Length | The length of the IE |
| Group ID | The Group ID can be set as an unreserved value |
| | between 0x2-0x9, e.g. 0x2. |
| T | Set to 1 to indicate this is a long format packet |
| 6TiSCH Control | This field indicates the type of the 6TiSCH |
| Message Code | control messages. The message code and |
| | type mapping can be the same as in TABLE 11. |
| 6TiSCH Control | The fields of each 6TiSCH control messages |
| Message Fields | as shown in TABLES 7-10. |

In another embodiment, the threshold values for dynamically adjusting the size of the bundle as described above can be configured via 6top commands using CoAP. Each threshold has an associated URI path as defined in TABLE 14 below. These URI paths are maintained by the BR and/or LLN devices. To retrieve or update these threshold values, the sender needs to issue a RESTful method, e.g., POST method, to the destination with the address set to the corresponding URI path; note that the destination maintains the corresponding URI path.

TABLE 14

| | Accessibility 6top | |
|---|---|---|
| CoAP Resource Name | Commands | URI path |
| Tₐ, Threshold value of an | READ/ | /TrackID/ |
| allocated queue to trigger a | CONFIGURE | TAllocatedQueue |
| procedure to decrease the size | | |
| of a bundle associated with a | | |
| Track. | | |
| Tₒ, Threshold value of an | READ/ | /TrackID/ |
| overflow queue to trigger a | CONFIGURE | TOverflowQueue |
| procedure to increase the size | | |
| of a bundle associated with a | | |
| Track. | | |
| Tₕ, Threshold value of the | READ/ | /TrackID/ |
| best effort queue to trigger a | CONFIGURE | THBesteffortQueue |
| procedure to increase the size | | |
| of a bundle associated with | | |
| best effort traffic. | | |
| Tₗ, Threshold value of the | READ/ | /TrackID/ |
| best effort queue to trigger a | CONFIGURE | TLBesteffortQueue |
| procedure to decrease the size | | |
| of a bundle not associated | | |
| with a Track. | | |

In another embodiment, 6TiSCH Control Messages can also be transmitted using CoAP. Each control message has an associated URI path as defined in TABLE 15. These URI paths are maintained by the BR and/or LLN devices. To send a control message to a destination, the sender needs to issue a RESTful method, e.g., POST method, to the destination with the address set to the corresponding URI path; note that the destination maintains the corresponding URI path.

TABLE 15

| 6TiSCH Control Message | CoAP Resource | URI path |
|---|---|---|
| Bundle Adjustment Request | Bundle adjustment | /BundleResizeReq |
| Message | request | |
| Bundle Adjustment Reply | Bundle adjustment | /BundleResizeRep |
| Message | Reply | |

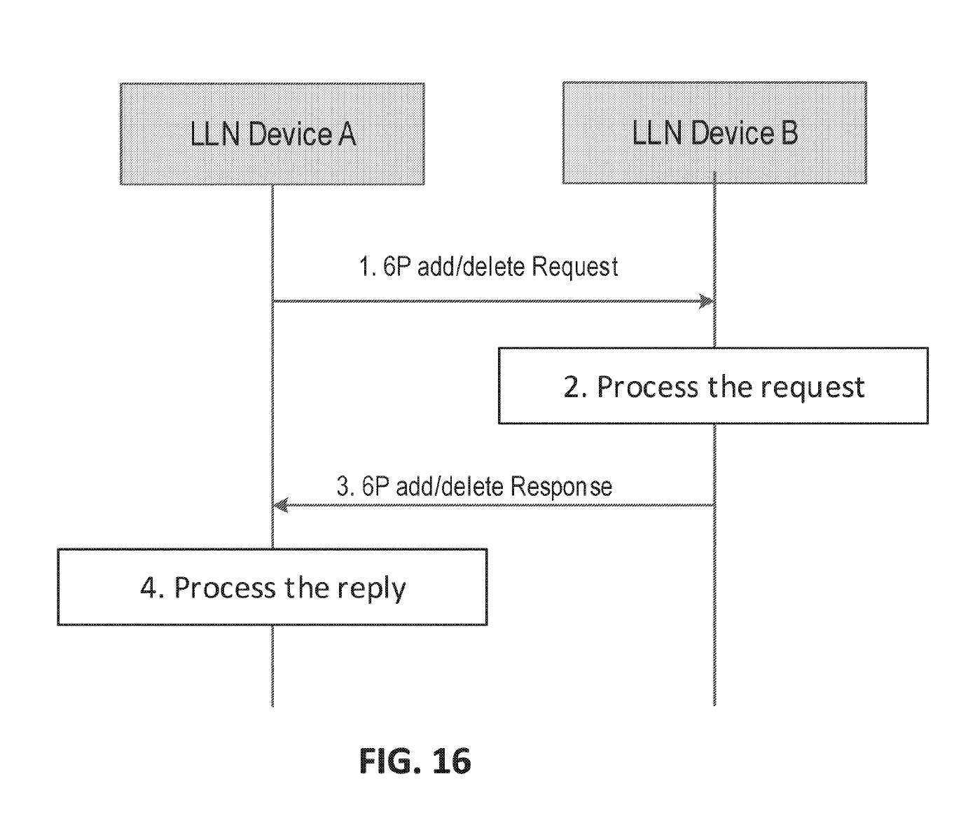

The bundle adjustment can be used to enhance the 6top Protocol (6P). In the procedures to add or delete soft cell in 6P as shown FIG. 16, new fields are added to the ADD and DELETE requests as shown in TABLES 16 and 17, respectively. After the LLN device B processes the request, it inserts extra fields in the response message.

TABLE 16

| Fields name | Description |
|---|---|
| Ver | Set to IANA_6P_VERSION. |
| Code | Set to IANA_CMD_ADD for a 6P ADD Request |
| SFID | Identifier of the SF to be used by the receiver to handle the |
| | message. |
| Track ID | The Track ID associated with the Bundle to be adjusted. The value |
| | is NULL if the Bundle is a layer 3 Bundle. |
| NumCells | The number of additional TX cells the sender wants to schedule to |
| | the receiver from the transmitter to the receiver for the Track |
| Container | An indication of where in the schedule to take the cells from |
| | (which slotframe, which chunk, etc.). This value is an indication |
| | to the SF. The meaning of this field depends on the SF, and is |
| | hence out of scope of this document. |
| Range of proposed cells | This field contains proposed cells by the transmitter to reserve, In |
| | particular, to reserve cells, it contains the range of all unscheduled |
| | cell of the transmitter that can be reserved for the receiver. In one |
| | implementation, this field can list the slot offset of all proposed |
| | cells. In another implementation, this field can list the slot offset of |
| | the first cell of the range and number of consecutive cells |
| | proposed. In yet another implementation, this field can list the slot |
| | offset of the first and last cell of the range proposed. |

TABLE 17

| Fields name | Description |
|---|---|
| Ver | Set to IANA_6P_VERSION. |
| Code | Set to IANA_CMD_DELETE for a 6P DELETE Request |
| SFID | Identifier of the SF to be used by the receiver to handle the |
| | message. |
| Track ID | The Track ID associated with the Bundle to be adjusted. The value |
| | is NULL if the Bundle is a layer 3 Bundle. |
| NumCells | The number of TX cells associated with the Track that the sender |
| | requests to release between the receiver. |
| Container | An indication of where in the schedule to take the cells from |
| | (which slotframe, which chunk, etc.). This value is an indication |
| | to the SF. The meaning of this field depends on the SF, and is |
| | hence out of scope of this document. |
| Range of proposed cells | This field contains proposed cells by the transmitter to release. In |
| | particular, to release cells, it contains the range of cell that can be |
| | released. In one implementation, this field can list the slot offset of |
| | all proposed cells. In another implementation, this field can list the |
| | slot offset of the first cell of the range and number of consecutive |
| | cells proposed. In yet another implementation, this field can list |
| | the slot offset of the first and last cell of the range proposed. |

TABLE 18

| | |
|---|---|
| Ver | Set to IANA_6P_VERSION |
| SFID | Identifier of the SF to be used by the receiver to handle the |
| | message. |
| Code | One of the 6P Return Codes |
| Track ID | The Track ID associated with the Bundle to be adjusted. If the |
| | value is NULL then the Bundle is a layer 3 Bundle. |
| Decision | The decision of the Bundle adjustment. The value is true if the |
| | transmitter has unscheduled slots that meet the request and is false |
| | otherwise. |
| Number of confirmed | The number of cells that is confirmed to be reserved or released |
| cells | |
| Range of confirmed cells | This field contains confirmed cells by the receiver to reserve or |
| | release. In particular, to reserve cells, it contains the range of all |
| | unscheduled cells of the receiver that can be reserved for the |
| | transmitter. To release cells, it contains the range of cells that can |
| | be released. In one implementation, this field can list the slot offset |
| | of all confirmed cells. In another implementation, this field can list |
| | the slot offset of the first cell of the range and number of |
| | consecutive cells confirmed. In yet another implementation, this |
| | field can list the slot offset of the first and last cells of the range |
| | confirmed. |
| Range of proposed cells | This field contains proposed cells by the receiver to reserve or |
| | release. In particular, to reserve cells, it contains the range of all |
| | unscheduled cells of the receiver that can be reserved for the |
| | transmitter. To release cells, it contains the range of cells that can |
| | be released. In one implementation, this field can list the slot offset |
| | of all proposed cells. In another implementation, this field can list |
| | the slot offset of the first cell of the range and number of |
| | consecutive cells proposed. In yet another implementation, this |
| | field can list the slot offset of the first and last cells of the range |
| | proposed. |

While the systems and methods have been described in terms of what are presently considered to be specific aspects, the application need not be limited to the disclosed aspects. It is intended to cover various modifications and similar arrangements included within the spirit and scope of the claims, the scope of which should be accorded the broadest interpretation so as to encompass all such modifications and similar structures. The present disclosure includes any and all aspects of the following claims.

1. An apparatus operating on a network comprising:
a non-transitory memory including an interface queue that stores a packet for a neighbor device, the interface queue having subqueues including a high priority subqueue, a track subqueue, and a best effort subqueue; and
a processor, operably coupled to the non-transitory memory, configured to perform the instructions of determining which of the subqueues to store the packet.

2. The apparatus of claim 1, wherein the track subqueue includes an allocated queue with a maximum size equal to the number of cells reserved on a track in the network.

3. The apparatus of claim 2, wherein the track subqueue includes an overflow queue to hold the packet when the allocated queue is full.

4. An apparatus operating on a network comprising:
a non-transitory memory including an interface queue designated for a neighboring device and having instructions stored thereon for enqueuing a received packet; and
a processor, operably coupled to the non-transitory memory, configured to perform the instructions of:
receiving the packet in a cell from the neighboring device;
checking whether a track ID is in the received packet;
checking a table stored in the memory to find a next hop address; and
inserting the packet into a subqueue of the interface queue.

5. The apparatus of claim 4, wherein the cell is associated with a per hop bundle, and wherein the processor is further configured to perform the instructions of checking whether a destination address matches a MAC address of the apparatus.

6. (canceled)

7. The apparatus of claim 5, wherein the inserting step includes confirming the priority of the packet, and wherein the packet is inserted into a high priority subqueue or a best effort subqueue.

8. (canceled)

9. The apparatus of claim 4, wherein the checking step includes evaluating whether a source address in a MAC layer frame and a track ID of the apparatus match information of a bundle associated with the cell.

10. The apparatus of claim 9, wherein the inserting step includes confirming space in an allocated subqueue, and wherein the packet is inserted into the allocated subqueue or an overflow subqueue.

11. (canceled)

12. An apparatus operating on a network comprising:
a non-transitory memory having an interface queue designated for a neighboring device and instructions stored thereon for dequeuing a packet; and
a processor, operably coupled to the non-transitory memory, configured to perform the instructions of:
evaluating the packet in a cell should be transmitted to the neighboring device;
determining whether a high priority subqueue of the interface queue is empty;
dequeuing the packet; and
transmitting the packet to the neighboring device.

13. The apparatus of claim 12, wherein the processor is further configured to determine whether an overflow subqueue of the interface queue is empty or an overflow subqueue of all track IDs in the network is empty.

14. The apparatus of claim 12, wherein the dequeuing step is selected from dequeuing a head packet of a priority subqueue, dequeuing a head packet of an overflow subqueue, and dequeuing a head packet of a best effort subqueue.

15. The apparatus of claim 12, wherein the processor is configured to check space of an allocated subqueue of the interface queue of the neighboring device prior to the determining step, and wherein the processor is configured to dequeue a packet in the head of the allocated subqueue associated with a track of the neighboring device prior to the determining step.

16. (canceled)

17. An apparatus operating on a network comprising:
a non-transitory memory including an interface queue with a subqueue for a neighboring device, and having instructions stored thereon for adjusting a bundle of the device in the network; and
a processor, operably coupled to the non-transitory memory, configured to perform the instructions of:
monitoring the length of the subqueue of the device;
determining the difference between the subqueue and a threshold value;
generating a bundle adjustment request to adjust the size of the subqueue; and
sending the bundle adjustment request to the device.

18. The apparatus of claim 17, wherein the subqueue is selected from an allocated subqueue, an overflow subqueue and a best effort subqueue.

19. The apparatus of claim 18, wherein the determining step includes evaluating the length of the allocated subqueue in relation to a bundle size of the allocated subqueue less a threshold value.

20. The apparatus of claim 18, wherein the determining step includes evaluating the length of the overflow subqueue in relation to a threshold value.

21. The apparatus of claim 18, wherein the determining step includes evaluating the length of the best effort subqueue in relation to a threshold value.

22. An apparatus operating on a network comprising:
a non-transitory memory including an interface queue with a subqueue for a neighboring device, and having instructions stored thereon for processing a bundle adjustment request from the neighboring device; and
a processor, operably coupled to the non-transitory memory, configured to perform the instructions of:
receiving a bundle adjustment request including information having a track ID;
extracting the information from the received requested;
generating a response in view of the extracted information; and
transmitting a response to the device.

23. The apparatus of claim 22, wherein the information includes reserving additional cells, and wherein the information includes determining unscheduled slots.

24. (canceled)

25. The apparatus of claim 22, wherein the processor is further configured to propose additional cells to the device if greater than a number of unscheduled slots, and wherein the generating step includes determining unscheduled slots in relation to the request, and set a number of cells for the device if less than a number of unscheduled slots, and wherein the generating step includes determining unscheduled slots in relation to the request.

26. (canceled)
